(19) United States
(12) Patent Application Publication
(10) Pub. No.: US 2026/0268495 A1
(43) Pub. Date: Sep. 10, 2026

(54) IMAGE-BASED TOOTH SEGMENTATION AND IDENTIFICATION

(71) Applicant: Align Technology, Inc., San Jose, CA (US)

(72) Inventors: Christopher E. Cramer, Durham, NC (US); Yun Gao, Cary, NC (US); Yixuan Huang, Cary, NC (US); Chao Shi, Morrisville, NC (US); Guotu Li, Apex, NC (US)

(21) Appl. No.: 19/556,660

(22) Filed: Mar. 4, 2026

Related U.S. Application Data
(60) Provisional application No. 63/767,210, filed on Mar. 5, 2025.

(51) Int. Cl. G06T 7/00; G06T 7/11; G06T 7/73; G06T 11/00; G06V 10/776; G06V 10/82; G06V 20/70; G06V 40/10

(52) U.S. Cl. CPC G06T 7/0016; G06T 7/11; G06T 7/74; G06T 11/00; G06V 10/82; G06V 20/70; G06V 40/10; G06T 2200/24; G06T 2207/30036; G06T 2210/41; G06V 10/776; G06V 2201/033

(57) ABSTRACT

Systems and methods for identifying teeth in a patient image are provided. A system can include processor(s) and a memory operably coupled to the processor(s) and storing instructions that, when executed by the processor(s), cause the system to perform operations including accessing a 2D image including a depiction of a patient's teeth, applying a segmentation algorithm to the 2D image, and generating tooth assignments. The segmentation algorithm may be configured to identify a plurality of regions in the 2D image, each region corresponding to an estimated location of a tooth of the patient's teeth in the 2D image, and determine a tooth mask and a tooth identifier for each tooth, where the determination for each tooth is based on features of the region corresponding to the estimated location of the tooth and features of the regions corresponding to estimated locations of one or more teeth proximate to the tooth.

### CROSS-REFERENCE TO RELATED APPLICATION(S)

The present application claims the benefit of priority to U.S. Provisional Application No. 63/767,210, filed Mar. 5, 2025, the disclosure of which is incorporated by reference herein in its entirety.

### TECHNICAL FIELD

The present technology generally relates to dentistry, and in particular, to systems and methods for image-based tooth segmentation and identification.

### BACKGROUND

Telemedicine systems can improve the convenience and accessibility of dental treatment by allowing clinicians to monitor the condition of a patient's teeth remotely. For instance, a clinician may evaluate the teeth and make treatment decisions based on photographs of the teeth, rather than requiring an in-person appointment to visually examine the teeth. However, the reliability and quality of remote dental treatment may be compromised if the teeth cannot be accurately and consistently identified in the patient photographs. Conventionally, tooth identification is performed manually by a human or automatically via image processing algorithms. Unfortunately, manual tooth identification can be time-consuming and prone to human error, and conventional techniques for automated tooth identification can be unreliable. For instance, both manual and conventional automated techniques may result in misidentified teeth, inconsistent tooth identifications across time, and more. These errors can critically affect downstream treatment decisions, planning, and/or modeling of the teeth. Therefore, there is a need for improved tooth identification systems and methods.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a block diagram providing a representative example of a workflow for identifying teeth in a patient image, in accordance with embodiments of the present technology.

FIG. 2A illustrates a representative example of a 2D image including a depiction of a patient's teeth, in accordance with embodiments of the present technology.

FIG. 2B illustrates a representative example of the 2D image of FIG. 2A with a plurality of tooth masks, in accordance with embodiments of the present technology.

FIG. 2C illustrates a representative example of the 2D image of FIG. 2A with a plurality of tooth masks and a plurality of tooth identifiers, in accordance with embodiments of the present technology.

FIGS. 3A and 3B illustrate a portion of a 2D image and a graphical representation of tooth identifier probabilities for the 2D image, respectively, in accordance with embodiments of the present technology.

FIGS. 4A-4F illustrates a representative example of a workflow for generating mask identifier probabilities, in accordance with embodiments of the present technology.

FIG. 5 is a block diagram illustrating a representative example of a workflow for identifying teeth in a patient image, in accordance with embodiments of the present technology.

FIG. 6 is a flow diagram illustrating a method for identifying teeth in a patient image, in accordance with embodiments of the present technology.

FIG. 7 is a block diagram illustrating a representative example of a workflow for identifying teeth in a patient image, in accordance with embodiments of the present technology.

FIG. 8 is a block diagram illustrating a representative example of a segmentation algorithm including a contextual module, in accordance with embodiments of the present technology.

FIG. 9 is a flow diagram illustrating a method for identifying teeth in a patient image, in accordance with embodiments of the present technology.

FIG. 10 is a block diagram illustrating a representative example of a workflow for identifying teeth in a patient image, in accordance with embodiments of the present technology.

FIG. 11 illustrates a representative example of a sequence processing algorithm, in accordance with embodiments of the present technology.

FIG. 12 is a flow diagram illustrating a method for identifying teeth in a patient image, in accordance with embodiments of the present technology.

FIGS. 13A-13C illustrate a representative example of a tooth identification process with and without use of a topological loss function, in accordance with embodiments of the present technology.

FIG. 14A illustrates a representative example of a tooth repositioning appliance configured in accordance with embodiments of the present technology.

FIG. 14B illustrates a tooth repositioning system including a plurality of appliances, in accordance with embodiments of the present technology.

FIG. 14C illustrates a method of orthodontic treatment using a plurality of appliances, in accordance with embodiments of the present technology.

FIG. 15 illustrates a method for designing an orthodontic appliance, in accordance with embodiments of the present technology.

FIG. 16 illustrates a method for digitally planning an orthodontic treatment and/or design or fabrication of an appliance, in accordance with embodiments of the present technology.

### DETAILED DESCRIPTION

The present technology relates to systems and methods for identifying teeth in patient images. In some embodiments, for example, a computer-implemented method for identifying teeth in a patient image includes accessing a two-dimensional (2D) image (e.g., a photograph) including a depiction of a patient's teeth. The 2D image can be composed of a plurality of pixels (e.g., the 2D image may be composed of 512 pixels by 512 pixels). The computer-implemented method may also include generating a set of tooth identifier probabilities by applying a first segmentation algorithm (e.g., a semantic segmentation algorithm) to the 2D image. Each tooth identifier probability can represent a likelihood that a pixel of the 2D image corresponds to a particular tooth identifier of a plurality of tooth identifiers for the teeth (e.g., a tooth identifier selected from #1-#32 in the universal numbering system). For instance, if the particular tooth identifier is for a left maxillary canine (tooth #11), a high tooth identifier probability for a pixel suggests that the pixel depicts the patient's left maxillary canine. The computer-implemented method may further include generating a set of tooth mask probabilities by applying a second segmentation algorithm (e.g., an object instance segmentation algorithm) to the 2D image. Each tooth mask probability can represent a likelihood that a pixel of the 2D image is associated with a particular tooth mask of a plurality of tooth masks for the teeth. As will be described later herein, a tooth mask may include a region or contour line defining a boundary of a particular tooth, and a high tooth mask probability for a pixel suggests that the pixel is within or proximate to the tooth's boundary. The computer-implemented method can further include generating a set of mask identifier probabilities by combining the set of tooth identifier probabilities and the set of tooth mask probabilities. Each mask identifier probability can represent a likelihood that a particular tooth mask of the plurality of tooth masks corresponds to a particular tooth identifier of the plurality of tooth identifiers (e.g., the likelihood that mask X corresponds to tooth #1). The computer-implemented method can further include assigning each tooth of the patient's teeth in the 2D image to a respective tooth mask of the plurality of tooth masks and a respective tooth identifier of the plurality of tooth identifiers, based on the set of mask identifier probabilities. Optionally, the computer-implemented method may further include outputting an indication of the tooth assignments to a user via a display.

Alternatively, in some embodiments, a computer-implemented method for segmenting a patient image includes, by one or more processors, accessing a 2D image including a depiction of a patient's teeth, where the 2D image is composed of a plurality of pixels. The computer-implemented method can further include transmitting, to a server computing device, the 2D image. The computer-implemented method can further include receiving, from the server computing device, a tooth assignment for each tooth of the patient's teeth in the 2D image. The tooth assignments can be generated by generating a set of tooth identifier probabilities by applying a first segmentation algorithm to the 2D image, generating a set of tooth mask probabilities by applying a second segmentation algorithm to the 2D image, generating a set of mask identifier probabilities by combining the set of tooth identifier probabilities and the set of tooth mask probabilities, and assigning each tooth of the patient's teeth in the 2D image to a respective tooth mask of the plurality of tooth masks and a respective tooth identifier of the plurality of tooth identifiers, based on the set of mask identifier probabilities. Optionally, the computer-implemented method may further include outputting an indication of the tooth assignments to a user via a display.

In some embodiments, a computer-implemented method for identifying teeth in a patient image includes, by one or more processors, accessing a two-dimensional (2D) image including a depiction of a patient's teeth. The computer-implemented method may further include transmitting, to a server computing device, the 2D image. The computer-implemented method may further include receiving, from the server computing device, a tooth assignment for each tooth of the patient's teeth in the 2D image, where the tooth assignments are generated by applying a segmentation algorithm to the 2D image. The segmentation algorithm may be configured to identify a plurality of regions in the 2D image, each region corresponding to an estimated location of a tooth of the patient's teeth in the 2D image, and determine a tooth mask and a tooth identifier for each tooth of the patient's teeth in the 2D image, where the determination for each tooth is based on features of the region corresponding to the estimated location of the tooth and features of the regions corresponding to estimated locations of one or more teeth proximate to the tooth. For example, the determination can be performed using a contextual module that incorporates contextual information into the determination of the tooth masks and tooth identifiers, e.g., via a self-attention mechanism. The computer-implemented method may further include generating tooth assignments by assigning each tooth of the patient's teeth in the 2D image to the respective determined tooth mask and the respective determined tooth identifier.

In some embodiments, a computer-implemented method for identifying teeth in a patient image includes, by one or more processors, accessing a two-dimensional (2D) image including a depiction of a patient's teeth. The computer-implemented method may further include transmitting, to a server computing device, the 2D image. The computer-implemented method may further include receiving, from the server computing device, a tooth assignment for each tooth of the patient's teeth in the 2D image, where the tooth assignments are generated by generating a tooth mask and a first tooth identifier for each tooth of the patient's teeth in the 2D image by applying a segmentation algorithm to the 2D image. The computer-implemented method can further include generating an input sequence including the tooth masks for the patient's teeth, where the tooth masks are ordered in the input sequence based on the first tooth identifiers. A second tooth identifier for each tooth mask can be determined by applying a sequence processing algorithm to the input sequence, where the sequence processing algorithm is configured to determine the second tooth identifier for each tooth mask based on features of the tooth masks of one or more teeth proximate to the tooth corresponding to the tooth mask, and generating tooth assignments by assigning each tooth of the patient's teeth in the 2D image to the respective tooth mask and the respective determined second tooth identifier. In some embodiments, the sequence processing algorithm is a recurrent neural network, such as a Bidirectional Long Short-Term Memory model, an encoder-decoder model, etc.

The present technology can provide various advantages compared to conventional techniques for tooth identification. For example, some conventional techniques involve manually identifying tooth boundaries and assigning a tooth identifier for each tooth. This can be time-consuming, labor-intensive, and prone to human error. Other conventional techniques involve the utilization of automated algorithms for assigning tooth boundaries and identifiers. However, the existing algorithms can generate incorrect tooth identifications and be difficult to interpret. For instance, issues may arise from the algorithms improperly identifying tooth boundaries, e.g., neighboring teeth may be confused for a single continuous tooth, a single tooth may be confused for multiple teeth, the identified boundary may not accurately depict the actual boundary between teeth, the identified boundary may not accurately depict anatomically plausible shapes, etc. Further, these algorithms may require complicated post-processing for error correction and/or validation. Moreover, some approaches for tooth identification assume a geometric (e.g., linear) ordering of teeth based on the relative locations of teeth in an image, but this assumption may be inappropriate for all patient views. For instance, if an image provides a buccal view of the patient's teeth, some of the posterior teeth may appear to be located between neighboring anterior teeth, and thus the order in which the teeth appear in the image may fail to match the actual ordering of the patient's teeth.

The present technology addresses these and other concerns by providing improved systems and methods for tooth identification from patient images. In some embodiments, a patient image is evaluated using multiple segmentation algorithms. The outputs of these segmentation algorithms can be combined to yield a more accurate tooth identification than if each algorithm were considered independently. Moreover, these segmentation algorithms can be combined in a way that leverages each algorithm's strengths. For instance, semantic segmentation algorithms may be able to accurately capture relational information of teeth in an image (e.g., the identity of each tooth, where the teeth are located in the image relative to one another) but may generate poorly defined boundaries between teeth and/or may not accurately identify the boundaries between teeth. On the other hand, object instance segmentation algorithms may provide well-defined and accurate boundaries between teeth but may incorrectly identify the identify of each tooth. Accordingly, some embodiments of the present technology combine the relational information captured via semantic segmentation with the boundary information captured via object instance segmentation to provide improved tooth identification. Further, some embodiments of the present technology may provide improved tooth ordering, where the tooth are ordered probabilistically, rather than solely based on their relative locations in the patient image. Moreover, some embodiments of the present technology include algorithms configured to process sequential or contextual information, such as spatial relationships between teeth. Additionally or alternatively, some embodiments of the present technology include algorithms configured to evaluate topological features, such as to refine segmentation masks to exclude anatomically implausible shapes. Any of these algorithms may be used in combination with a segmentation algorithm or may be incorporated into a segmentation algorithm. Independently or in combination, the techniques described herein can provide more accurate tooth identification than conventional techniques, particularly for challenging patient images such as images of patients with primary dentition and images of patients wearing dental appliances. Moreover, the present technology is applicable to many different types of image data, such as intraoral photographs, extraoral photographs, and radiographs.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Image-Based Tooth Identification

The present technology provides systems and methods for identifying teeth in patient images. Tooth identification can be a significant step in patient monitoring, treatment planning, and/or the construction of dental models. Correct tooth identification can allow a clinician and/or automated software algorithm to reliably assess a patient's dental condition and/or design a suitable treatment plan. In contrast, incorrect tooth identification may lead to a misdiagnosis, and possibly ineffective and/or adverse treatment outcomes, such as the wrong tooth being repositioned.

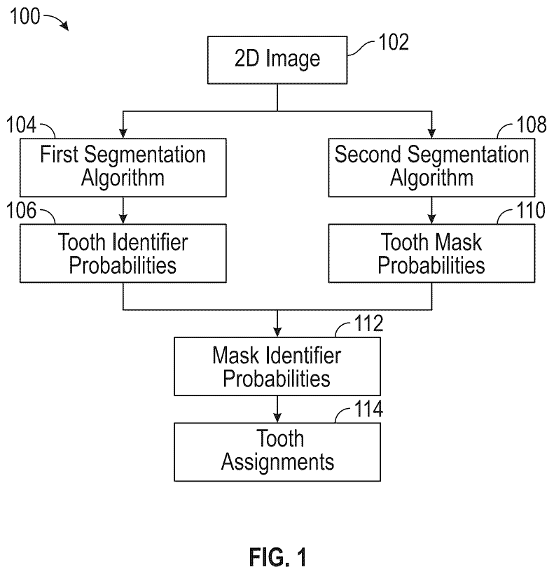

FIG. 1 is a block diagram illustrating a representative example of a workflow 100 for identifying teeth in a patient image, in accordance with embodiments of the present technology. In some embodiments, some or all of the processes described with respect to the workflow 100 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety. The workflow 100 can be utilized and/or combined with any of the other workflows and/or methods described herein.

The workflow 100 can include accessing a 2D image 102 including a depiction of a patient's teeth. The 2D image 102 can include any suitable image data type, such as one or more photographs (e.g., intraoral photographs, extraoral photographs), one or more frames of a video (e.g., selected from the video based on features present in the frames and/or a target view of a depicted scene), one or more radiographs, etc. The 2D image 102 can depict the patient from any suitable view, such as a front view of the patient's head while smiling, a close-up view of the patient's upper jaw, a close-up view of the patient's lower jaw, buccal views with the jaw open, buccal views with the jaw closed, occlusal views, lingual views, etc. The appropriate view may be determined based on the particular dental condition or treatment of interest, e.g., an upper occlusal view may be relevant for a patient who is undergoing or is being evaluated for palatal expansion therapy. In some situations, only some of the patient's teeth are depicted in the 2D image 102. For example, some of the patient's teeth may be covered by the patient's lips, dental appliances, and/or other objects. Optionally, the 2D image 102 may include metadata indicating the image type, e.g., the dental view, whether dental appliances are presented, etc.

The 2D image 102 can be obtained using any suitable imaging device, such as a digital camera (e.g., a DSLR camera, a mirrorless camera). Optionally, the imaging device can be part of or can be operably coupled to a computing device (e.g., a mobile device such as a smartphone or tablet; a desktop device; a server). The computing device may be operated by or associated with the patient, a healthcare provider (e.g., a clinician), or other suitable user. Alternatively or in combination, the 2D image 102 can be derived from scan data (e.g., intraoral and/or extraoral scans), magnetic resonance imaging (MRI) data, and/or radiographic data (e.g., standard x-ray data such as bitewing x-ray data, panoramic x-ray data, cephalometric x-ray data, computed tomography (CT) data, cone-beam computed tomography (CBCT) data, fluoroscopy data).

In some embodiments, the 2D image 102 is obtained using the imaging device only, without assistance from any auxiliary devices. In other embodiments, however, the 2D image 102 can be obtained using the imaging device in combination with an auxiliary device to position the imaging device in a fixed spatial location with respect to the patient's teeth and/or to retract the patient's cheeks and lips to improve visibility of the teeth. For example, the auxiliary device can include one or more cheek retractors. As another example, the auxiliary device can be a tube-type device including a smartphone interface configured to couple to a smartphone (or other mobile device with a camera), a patient interface configured to retract the patient's cheeks and lips, and a tubular body between the smartphone interface and the patient interface with a lumen extending therethrough, e.g., as described in U.S. Patent Application Publication No. 2022/0338723, the disclosure of which is incorporated by reference herein in its entirety. Other representative examples of systems, methods, and devices for obtaining 2D images of a patient are provided in U.S. Patent Application Publication No. 2022/0023003. In some embodiments, the obtained images may be transmitted to a remote server or some other computing system (e.g., on a local network) for performing some or all of the subsequent steps.

In some embodiments, the 2D image 102 is accessed from a database, such as an image repository. The image repository can be part of a local computing system, such as a dental treatment system or a machine learning system. Optionally, the 2D image 102 may be stored on a mobile device, such as a smartphone. Alternatively or additionally, the 2D image 102 may be stored on a remote server.

The 2D image 102 can be composed of a plurality of pixels. For instance, the 2D image 102 can be a 512 by 512 pixel image, or have any other suitable number of pixels. While the techniques of the present disclosure are herein described primarily with respect to pixels, it should be understood that the techniques are additionally or alternatively applicable to other image unit types. For instance, the techniques described herein may be applied to an image unit less than a pixel (e.g., a subpixel), an image unit greater than a pixel (e.g., a group of pixels or an image region), or another image unit altogether (e.g., points, dots, lines, inches, centimeters, millimeters). Further, examples illustrated and/or provided herein with respect to specific image dimensions are not intended to be limiting; the techniques described herein are also applicable to images having smaller, equivalent, or larger dimensions.

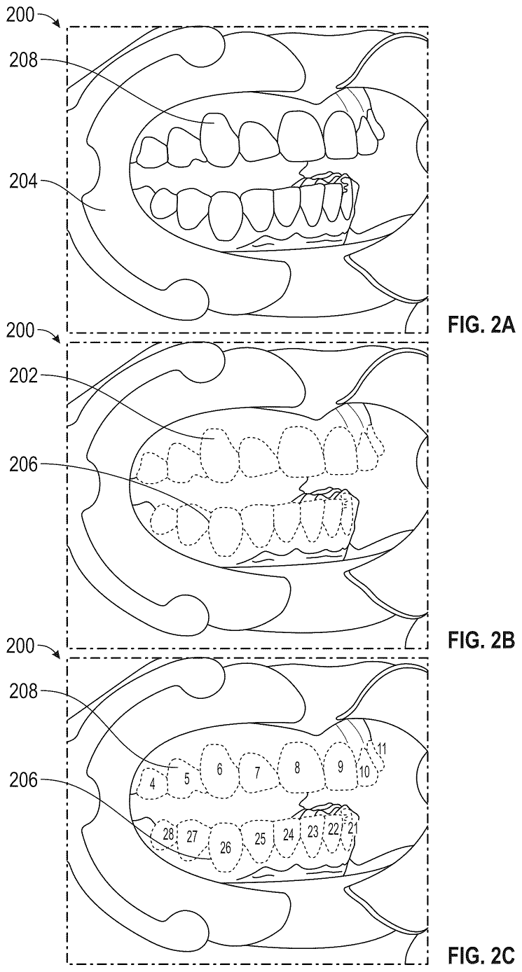

FIG. 2A illustrates a representative example of a 2D image 200 including a depiction of a patient's teeth 202, in accordance with embodiments of the present technology. The 2D image 200 provides an example of the 2D image 102 of the workflow 100 of FIG. 1. For instance, the 2D image 200 can be a photograph of the patient's face, and the 2D image 200 can be composed of a plurality of pixels. In the illustrated embodiment, a right buccal view of the patient's face is shown, and the patient's face is depicted with the patient's jaws open. Further, the 2D image 200 depicts an auxiliary device 204 in the form of a set of cheek retractors configured to retract the patient's cheeks and lips to improve visibility of the patient's teeth 202. Optionally, a dental appliance may also be depicted in the 2D image 200, such as a dental aligner positioned on the patient's teeth 202.

As previously noted, it may be desirable to identify the patient's teeth in the 2D image 200, e.g., for diagnosing a dental condition of the patient's teeth, developing a treatment plan for the patient's teeth, and/or monitoring progress of the patient's teeth with respect to a treatment plan. As will be described below, the workflow 100 of FIG. 1 can be used to identify the patient's teeth using a combination of segmentation algorithms.

Returning to FIG. 1, the workflow 100 can include inputting the 2D image 102 into a first segmentation algorithm 104. The first segmentation algorithm 104 can be used to determine which pixels of the 2D image 102 are likely to depict which teeth. For instance, the first segmentation algorithm 104 can be used to generate a set of tooth identifier probabilities 106, where each tooth identifier probability 106 represents a likelihood that a pixel of the 2D image 102 corresponds to a particular tooth identifier (e.g., a tooth number that identifies a tooth as specified in a dental notation system such as the Universal Numbering System or FDI Notation) of a plurality of tooth identifiers for the patient's teeth. In some embodiments, each pixel of the 2D image 102 is assigned a tooth identifier probability for each possible tooth identifier. As an example, each pixel can be evaluated for whether it likely depicts a first tooth (e.g., the third molar of the right maxillary, sometimes referred to as tooth #1), a second tooth (e.g., the second molar of the right maxillary, sometimes referred to as tooth #2), and so on. As a result, a distribution of tooth identifier probabilities can be generated for each pixel. Continuing the previous example, a pixel may be assigned an 80% likelihood of being the first tooth, a 10% likelihood of being the second tooth, etc.

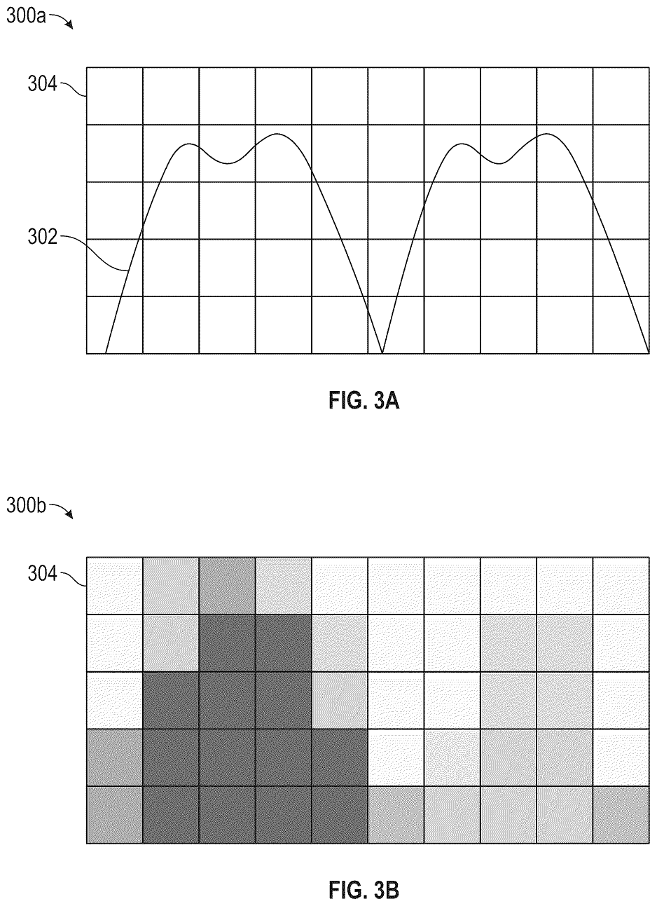

FIGS. 3A and 3B illustrate a portion of a 2D image 300a and a graphical representation 300b of tooth identifier probabilities for the 2D image 300a, respectively, in accordance with embodiments of the present technology. In some embodiments, the tooth identifier probabilities are produced by the first segmentation algorithm 104 of the workflow 100 of FIG. 1 (e.g., semantic segmentation). The 2D image 300a of FIG. 3A depicts a patient's teeth (e.g., similar to the 2D image 200 of FIG. 2) and is composed of a plurality of pixels 304. The graphical representation 302 of FIG. 3B illustrates the probability that each pixel 304 in the 2D image 300 of FIG. 3A corresponds to tooth identifier #1. In the illustrated example, corresponding pixels 304 in the graphical representation 302 are grayscaled such that darker shading is indicative that a pixel 304 has a higher probability of corresponding to tooth identifier #1 and lighter shading is indicative that a pixel 304 has a lower probability of corresponding to the tooth identifier #1 (e.g., black=100% probability, white=0% probability). As shown, the pixels 304 in the left half of the graphical representation 302 generally have higher probabilities than the pixels 304 in the right half of the graphical representation 302, thus suggesting that the tooth in the left side of the 2D image 300 of FIG. 3A is more likely to be tooth #1 than the tooth in the right side of the 2D image 300 of FIG. 3A.

Referring again to FIG. 1, a tooth identifier can be any form of data such as a label, tag, designation, etc. that conveys a particular tooth's identity. For instance, a tooth identifier can be or include numbers (e.g., 1, 2, 3, etc.), letters, symbols (e.g., +, −, *, etc.), descriptors (e.g., “canine,” “molar,” “incisor,” “supernumerary,” etc.), colors (e.g., red, green, blue, etc.), patterns (e.g., striped, dotted, etc.), and/or any other suitable notations. The plurality of tooth identifiers may be derived from a dental notation system, such as the universal numbering system which ranges from tooth #1 to tooth #32 (e.g., as used in the example in the preceding paragraph). Other dental notation systems are possible, such as Palmer notation and/or the FDI World Dental Federation notation. Additionally or alternatively, a clinician may have preferred and/or unique notation systems for their patients. Regardless of the desired notation system, tooth identifiers can relay relevant information regarding a given tooth's shape, position, condition, etc.

Optionally, the tooth identifier probabilities can include a probability representing the likelihood that a pixel of the 2D image 102 does not depict a tooth, and instead depicts a different type of anatomical structure (e.g., gingiva) or otherwise depicts an object that is not of interest (e.g., “background”). For instance, each pixel in the 2D image 102 can be assigned 33 tooth identifier probabilities: one tooth identifier probability for each of the 32 teeth in the universal numbering system (#1 to #32) and one tooth identifier probability indicating that the pixel depicts a non-tooth and/or “background” object. In some embodiments, additional tooth identifier probabilities may be employed (e.g., for representing supernumerary teeth, both primary teeth and secondary teeth for patients with mixed dentition, gingiva, tongue, tooth attachments or other dental auxiliaries, etc.).

In some embodiments, the first segmentation algorithm 104 is or includes a semantic segmentation algorithm, e.g., as described in U.S. Patent Application Publication Nos. 2022/0023003 and 2023/0225831, the disclosures of which are incorporated by reference herein in their entirety. The semantic segmentation algorithm can be any segmentation algorithm that assigns a category to each pixel of the 2D image 102 (e.g., a category corresponding to one or more of the tooth identifiers). In some embodiments, the semantic segmentation algorithm includes one or more feature extraction processes in which features are extracted for each pixel, and one or more classification processes in which tooth identifier probabilities are assigned to each pixel based on the extracted features for the pixel. However, the semantic segmentation algorithm may alternatively or additionally include other processes, such as one or more pre-processing operations (e.g., denoising, filtering, error correction, gap filling, color correction, upsampling, downsampling).

In some embodiments, the first segmentation algorithm 104 includes a MultiScale Attention Network (MANet) with a pre-trained Mix-Vision transformer backbone. Alternatively or in combination, the first segmentation algorithm 104 can be or include one or more of U-Net, DeepLab, DeepLabv2, DeepLabv3, Feature Pyramid Network (FPN), Pyramid Scene Parsing Network (PSPNet), or any other suitable algorithm. Optionally, the first segmentation algorithm 104 may include a function for generating probability distributions from relative values, such as a softmax function, sigmoid function, regression, etc.

In some embodiments, the workflow 100 also includes inputting the 2D image 102 into a second segmentation algorithm 108. The second segmentation algorithm 108 can be used to identify tooth boundaries in the patient image. In some embodiments, these tooth boundaries are represented by a plurality of tooth masks, each tooth mask representing a region of the 2D image 102 corresponding to an individual tooth. For instance, the second segmentation algorithm 108 can segment the 2D image 102 into a set of n tooth masks M₁-Mₙ, where M₁ is a region of the 2D image 102 depicting a first tooth, M₂ is a region of the 2D image 102 depicting a second tooth, etc. The tooth masks can be any digital representation of the shape, size, and location of the tooth boundaries in the 2D image 102. For example, the tooth masks can include a series of contour lines representing tooth boundaries for the individual teeth. Alternatively or in combination, the tooth masks can include areas representing tooth geometries for each tooth, such as the regions enclosed by one or more contour lines. The second segmentation algorithm may be performed in parallel with the first segmentation algorithm (e.g., simultaneously or partially overlapping time periods) or may be performed at different times (e.g., after or before the first segmentation algorithm).

The second segmentation algorithm 108 can also be used to generate a set of tooth mask probabilities 110 based on the 2D image 102 and the plurality of tooth masks. Each tooth mask probability may represent a likelihood that a pixel of the 2D image 102 is associated with a particular tooth mask of the plurality of tooth masks. As an example, each pixel can be evaluated for whether it likely is associated with a first tooth mask M₁, a second tooth mask M₂, etc. of the plurality of tooth masks M₁-Mₙ. As a result, a distribution of tooth mask probabilities can be generated for each pixel. Continuing the previous example, a pixel may be assigned a 10% likelihood of being associated with the first tooth mask M₁, a 50% likelihood of being associated with the second tooth mask M₂, etc.

FIG. 2B illustrates a representative example of a plurality of tooth masks 206 for the patient's teeth 202 depicted in the 2D image 200 of FIG. 2A, in accordance with embodiments of the present technology. In some embodiments, the tooth masks 206 are produced by the second segmentation algorithm 108 of the workflow 100 of FIG. 1. The second segmentation algorithm 108 can identify a boundary for each of the patient's teeth 202 in the 2D image 200, the boundary corresponding to one of the tooth masks 206. For each pixel in the 2D image, a tooth mask probability can be calculated that represents the likelihood that the pixel belongs to a particular tooth mask 206 of the plurality of tooth masks 206.

Referring again to FIG. 1, in some embodiments, the second segmentation algorithm 108 is or includes an object instance segmentation algorithm. The object instance segmentation algorithm can be any segmentation algorithm that identifies and assigns object boundaries in a 2D image. Optionally, the object segmentation algorithm may also classify objects in the 2D image. In some embodiments, the classification may be a binary classification (e.g., a mask that classifies a pixel as being associated with a particular tooth or not being associated with the particular tooth). The object segmentation algorithm may include one or more of the following steps: identifying distinct regions in the image, extracting features from the distinct regions, classifying each of the distinct regions, assigning segmentation masks based on the distinct regions, distinguishing between the segmentation masks, etc. In some embodiments, object instance segmentation is performed on the 2D image 102 under a one-class paradigm, where only teeth, as opposed to other objects, are classified in the 2D image 102 and segmentation masks are created for individual teeth.

In some embodiments, the second segmentation algorithm 108 is or includes a neural network, such as a convolutional neural network (CNN). CNNs are a type of machine learning algorithm that can be used in the processing of images and/or other array-like data structures. A CNN is composed of a plurality of layers, with each layer including one or more neurons to which the operations described herein are applied. The CNN can transform input data (e.g., data received at an input layer) into output data (e.g., data output by an output layer) through a network architecture including a plurality of intermediate layers. In some embodiments, the plurality of intermediate layers includes one or more convolutional layers. Each convolutional layer of a CNN can apply at least one filter (also known as a “kernel”) to input data from a preceding layer via a convolutional operation. The parameters of the kernel (e.g., kernel size, weight, biases, parameters of the kernel function(s)) can be learned from training data (e.g., using backpropagation). The CNN can optionally include multiple convolutional layers, with the input data for each convolutional layer including output data from a preceding layer (e.g., another convolutional layer or another type of layer).

In some embodiments, the CNN includes one or more additional layers besides the one or more convolutional layers, such as at least one pooling layer and/or at least one fully connected layer. The at least one pooling layer can apply a spatial reduction operation to a preceding layer. In some embodiments, the at least one pooling layer performs dimensionality reduction. The at least one pooling layer can apply any variety of operations, such as max pooling, min pooling, average pooling, and global pooling. The at least one fully connected layer is connected to all preceding and succeeding layers. The at least one fully connected layer can apply a transformation to a preceding layer. In some embodiments, the at least one fully connected layer includes a linear transformation (e.g., affine functions). In some embodiments, the at least one fully connected layer includes a non-linear transformation (e.g., sigmoid, softmax, tanh, rectified linear unit functions). While the CNN has been discussed with respect to the plurality of layers, it should be understood that any of the layers can include one or more neurons at which operations are applied. Further, the CNN can include any arrangement of layers forming a customized network architecture. The determination produced by the CNN can include output data from a convolutional layer, pooling layer, fully connected layer, or any other layer of the CNN.

In some embodiments, the CNN is or includes a Mask R-CNN algorithm. The Mask R-CNN algorithm can have a backbone network, such as ResNet or ResNeXt. The backbone network can be configured to receive the 2D image 102 and extract features from the 2D image 102. The Mask R-CNN can also include a feature pyramid network (FPN), a region proposal network (RPN), region of interest align (ROIAlign) layer, and/or one or more mask heads configured to generate segmentation masks. Alternatively or in combination, the second segmentation algorithm 108 can be or include a Faster R-CNN algorithm, PolarMask++ algorithm, YOLACT algorithm, YOLO algorithm, YOLOv8 algorithm, Single-Shot Instance Segmentation with Affinity Pyramid (SSAP) algorithm, BlendMask algorithm, CondInst algorithm, SOLO algorithm, MeINST algorithm, CenterMask algorithm, DETR algorithm, RetinaNet algorithm, Mask2Former algorithm, or any other suitable algorithm.

In some embodiments, the workflow 100 further includes combining the tooth identifier probabilities 106 and the tooth mask probabilities 110 to produce mask identifier probabilities 112. Each mask identifier probability may represent a likelihood that a particular tooth mask of the plurality of tooth masks should be annotated with a particular tooth identifier of the plurality of tooth identifiers. In some embodiments, each tooth mask is assigned a mask identifier probability for each possible tooth identifier. As an example, each tooth mask can be evaluated for whether it likely is associated with a first tooth (e.g., the third molar of the right maxillary, sometimes referred to as tooth #1), a second tooth (e.g., the second molar of the right maxillary, sometimes referred to as tooth #2), and so on. As a result, a distribution of mask identifier probabilities can be generated for each tooth mask. Continuing the previous example, a mask identifier may be assigned a 50% likelihood of corresponding to the first tooth, a 30% likelihood of corresponding to the second tooth, etc.

In some embodiments, combining the tooth identifier probabilities 106 and the tooth mask probabilities 110 includes performing a series of mathematical operations, such as multiplying, summing, averaging, etc. For instance, the tooth identifier probabilities 106 and the tooth mask probabilities 110 can be represented as respective sets of matrices, and the matrices can be mathematically combined to generate a single matrix representing the mask identifier probabilities 112.

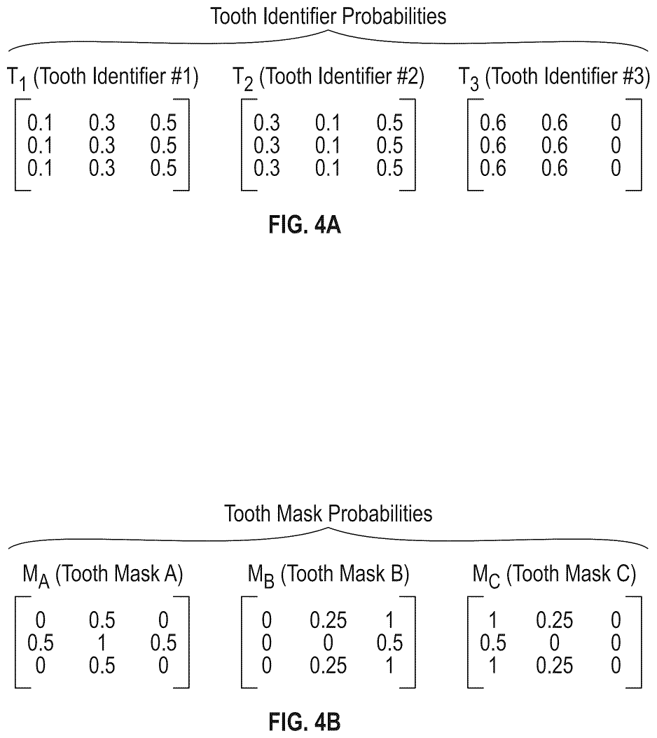

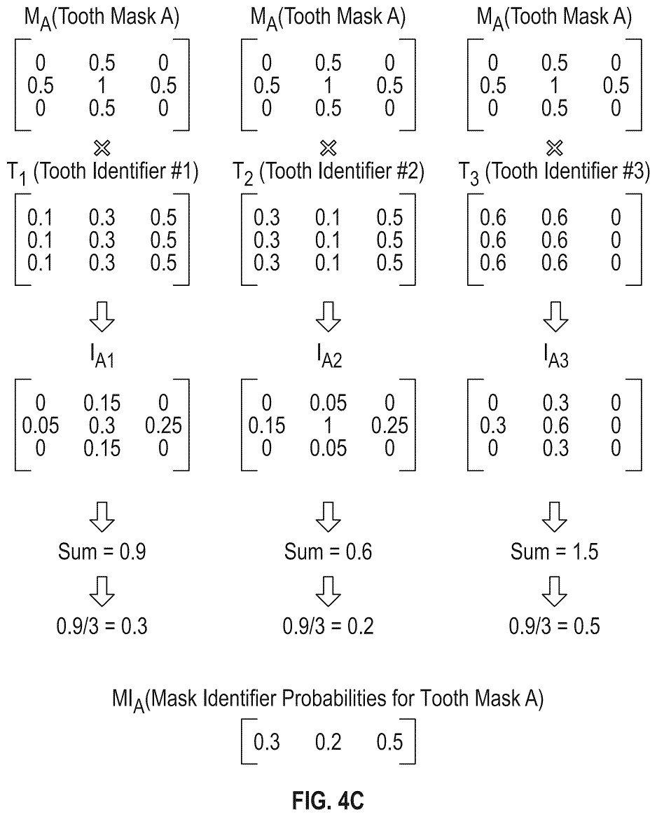

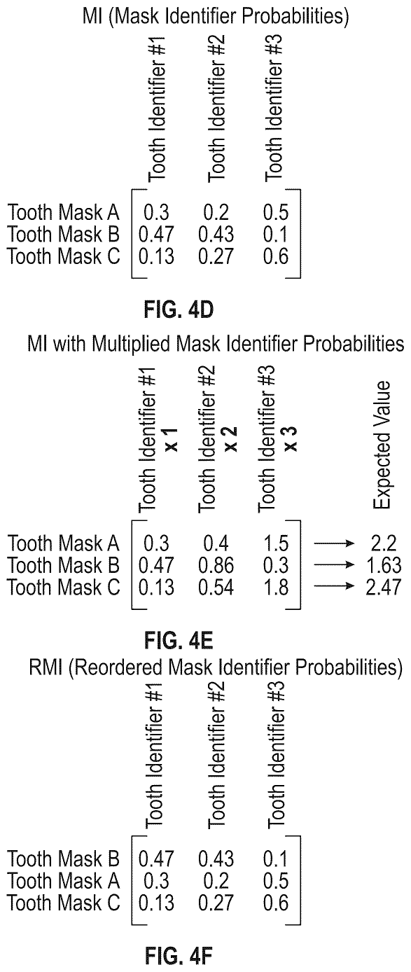

FIGS. 4A-4D illustrate a simplified example of a workflow for generating mask identifier probabilities, in accordance with embodiments of the present technology. For purposes of simplicity, the following assumptions are made in this example: the input patient image is composed of 3 pixels by 3 pixels, there are three possible tooth identifiers for the pixels in the patient image (#1-#3), and there are three possible tooth masks for the pixels in the patient image (A-C). However, it will be appreciated that the techniques described in FIGS. 4A-4D can be applied to patient images of any suitable size, to any number of possible tooth identifiers, and any number of possible tooth masks.

As shown in FIG. 4A, a first segmentation algorithm (e.g., a semantic segmentation algorithm) can be applied to the 2D image to produce a set of tooth identifier probabilities {T₁, T₂, T₃}, where Tₓ is a matrix of the probabilities that each pixel in the image corresponds to a particular tooth identifier x selected from the set of possible tooth identifiers (#1-#3).

As shown in FIG. 4B, a second segmentation algorithm (e.g., an object instance segmentation algorithm) can be applied to the patient image to provide a set of tooth mask probabilities {M_{A}, M_{B}, M_{C}}, where M_{y} is a matrix of the probabilities that each pixel in the image corresponds to a particular tooth mask y selected from the set of possible tooth masks (A-C).

A set of mask identifier probabilities representing the likelihoods that mask A corresponds to tooth identifiers #1-#3 can be determined as follows. As shown in FIG. 4C, element-wise multiplication is performed between the tooth mask probabilities for mask A (M_{A}) and each of the tooth identifier probabilities (T₁, T₂, T₃) to generate intermediate matrices (I_{A1}, I_{A2}, I_{A3}). The sum of the matrix elements in each intermediate matrix is then calculated and divided by the sum of the matrix elements in M_{A} (3 in this example). Thus, the mask identifier probabilities for mask A can be represented by a single row matrix MI_{A}, where the matrix element in column 1 represents the probability that mask A corresponds to tooth identifier #1 (30% in this example), the matrix element in column 2 represents the probability that mask A corresponds to tooth identifier #2 (20% in this example), and the matrix element in column 3 represents the probability that mask A corresponds to tooth identifier #3 (50% in this example).

As shown in FIG. 4D, this process can be repeated for masks B and C. The mask identifier probabilities for masks A-C can be appended to produce a single matrix of mask identifier probabilities MI in which the rows of the matrix correspond to the potential tooth masks, the columns of the matrix correspond to the potential tooth identifiers, and each matrix element represents a likelihood that a particular tooth mask corresponds to a particular tooth identifier.

Returning to FIG. 1, the workflow 100 can further include determining tooth assignments 114 for the 2D image 102. In some embodiments, the tooth assignments 114 include one or more tooth masks that define boundaries of one or more subregions of the 2D image 102 as corresponding to objects of interest within the 2D image 102 (e.g., using a first mask representing the boundaries of a first tooth, a second mask representing the boundaries of a second tooth) and a tooth identifier for each defined subregion (e.g., representing the likely identities of the first and second teeth) in the 2D image 102. Stated differently, each tooth in the 2D image 102 can be assigned a tooth mask selected from the plurality of tooth masks and assigned a tooth identifier selected from the plurality of tooth identifiers, where the assignment of the tooth masks and tooth identifiers have a high or maximum likelihood of being correct, based on the mask identifier probabilities 112. In some embodiments, one or more optimization algorithms such as a maximum likelihood algorithm are used to determine the tooth assignments 114 that are most likely to be correct. For instance, a maximum likelihood algorithm may be used to determine the tooth assignments 114 by evaluating the distribution of mask identifier probabilities 112 (e.g., the matrix shown in FIG. 4D). The maximum likelihood algorithm may resolve conflicts in the mask identifier probabilities 112, such as when a first tooth mask M₁ and a second tooth mask M₂ both have a 50% likelihood of being tooth #1. The maximum likelihood algorithm may evaluate how individual tooth assignments can affect other tooth assignments and/or the overall accuracy of the tooth assignments. Further details of maximum likelihood algorithms and other techniques that may be used to determine the tooth assignments 114 are described in U.S. Pat. No. 11,357,598, the disclosure of which is incorporated by reference herein in its entirety. Although the disclosure focuses on identifying and classifying teeth in a 2D image, the disclosure also contemplates identifying other objects of interest. For example, subregions within the 2D image 102 may be identified as including a variety of objects of interest (e.g., using masks representing boundaries of different teeth, gingiva, tongue, and/or attachments), and each of these objects of interest may be assigned an identifier (e.g., tooth #1, tooth #2, gingiva, tongue, attachment #1) using the methods described herein.

The tooth assignments 114 may be output to a user (e.g., a clinician, a patient) in any suitable manner. In some embodiments, the tooth assignments 114 are displayed as overlays, annotations, etc., on the 2D image 102. For instance, the tooth assignments 114 (e.g., tooth masks labeled with the corresponding identifiers) can be superimposed on the patient's teeth in the 2D image 102. Optionally, the tooth assignments 114 may be alternatively or additionally stored as metadata associated with the 2D image 102. In some embodiments, the tooth assignments 114 are stored as a tooth segmentation mask corresponding to the 2D image 102, where the tooth segmentation mask is a 2D digital representation (e.g., a 2D image) including the determined tooth masks, which may be represented as a series of contour lines representing tooth boundaries for the individual teeth, areas representing tooth geometries for each tooth (such as the regions enclosed by the contour lines), etc. The tooth segmentation mask can further include the tooth identifiers for each tooth, which may be incorporated into the 2D digital representation itself (e.g., as pixel values, labels, symbols) or may be metadata associated with 2D digital representation. In some embodiments, the tooth segmentation mask is depicted together with the 2D image, e.g., as an overlay on the patient's teeth. Additionally or alternatively, the tooth segmentation mask can be depicted in another image separate from the 2D image, and/or the tooth segmentation mask may be included in metadata associated with the 2D image.

FIG. 2C illustrates a representative example of a plurality of tooth assignments 208 for the patient's teeth 202 depicted in the 2D image 200 of FIG. 2A, in accordance with embodiments of the present technology. As depicted, the tooth assignments 208 can include tooth masks 206 labeled with corresponding tooth identifiers.

Referring again to FIG. 1, the tooth assignments 114 and/or the 2D image 102 can then be used in dental monitoring, treatment planning, and/or the construction of dental models. For instance, a clinician and/or an automated software algorithm may diagnose the patient with an oral disease or condition based on the shape, location, and/or absence of teeth in the 2D image 102, e.g., as indicated by the tooth assignments 114. As another example, the clinician and/or automated software algorithm may determine whether the patient's dentition is satisfactorily progressing according to a treatment stage of a treatment plan configured to reposition the patient's teeth.

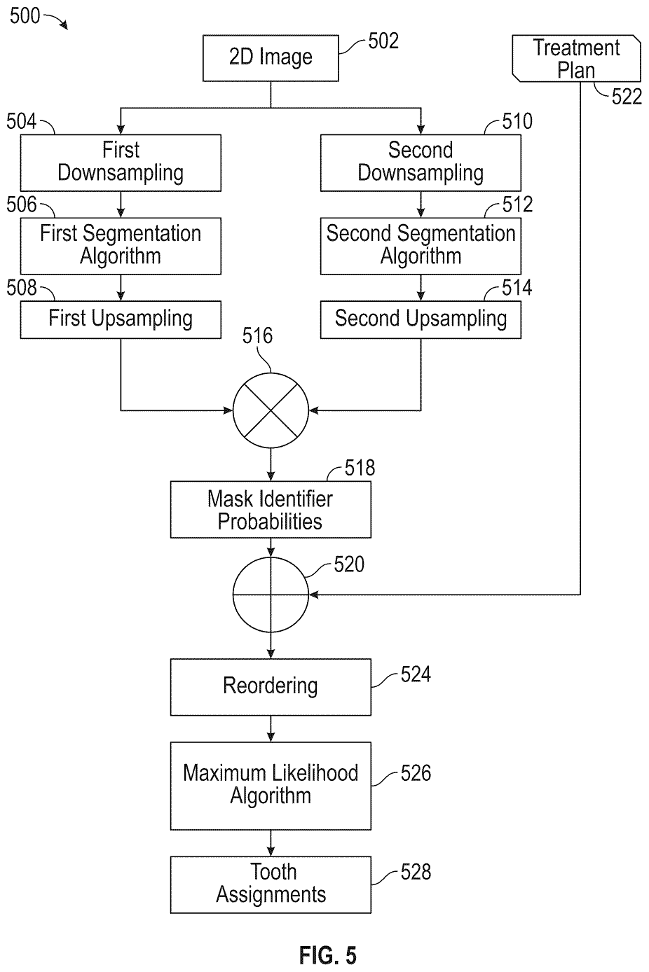

FIG. 5 is a block diagram illustrating a representative example of a workflow 500 for identifying teeth in a patient image, in accordance with embodiments of the present technology. In some embodiments, some or all of the processes described with respect to the workflow 500 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003. The workflow 500 can be utilized and/or combined with any of the other workflows and/or methods described herein, such as the workflow 100 of FIG. 1.

The workflow 500 can include accessing a 2D image 502 including a depiction of the patient's teeth. The 2D image 502 can be generally similar or identical to any of the 2D images described herein, such as the 2D image 102 of the workflow 100 of FIG. 1 or the 2D image 200 of FIG. 2A. For instance, the 2D image 502 can be a photograph of the patient's face (e.g., an intraoral or extraoral photograph), and the 2D image 502 can be composed of a plurality of pixels.

The workflow 500 can also include performing a first downsampling 504 of the 2D image 502 to produce a first downsampled 2D image. In some embodiments, the first downsampling 504 includes downsampling the 2D image 502 from an initial image resolution to a lower image resolution, e.g., for purposes of preprocessing the 2D image 502 for input into a first segmentation algorithm 506 as discussed below. The 2D image 502 can be downsampled to a fixed size, a proportional size (e.g., the smallest dimension of the 2D image 502 is scaled to a given value), or a proportional size with constraints (e.g., the width and/or height of the 2D image 502 must be divisible by 16, 32, 64, etc.). For instance, where the 2D image 502 is composed of 512 by 512 pixels, the 2D image 502 can be downsampled to 256 by 256 pixels, or any other suitable number of pixels. The first downsampling 504 can be performed by one or more of nearest neighbor sampling, bilinear interpolation, bicubic interpolation, gaussian blur, decimation, pyramid downsampling, box downsampling, resampling, random sampling, etc. For instance, the first downsampling 504 can include grouping one or more pixels together. Alternatively or in addition, the first downsampling 504 can include discarding pixels in the 2D image 502. Other types of image pre-processing may be performed in combination with or as an alternative to the first downsampling 504, such as converting the 2D image 502 to a tensor, converting uint8 pixels to z-score values, or other modifiers. Moreover, in some embodiments, the first downsampling 504 is optional, such that the subsequent processes of the workflow 500 are performed on the initial 2D image 502 rather than the first downsampled 2D image.

The workflow 500 can also include inputting the first downsampled 2D image into a first segmentation algorithm 506. The first segmentation algorithm 506 can be generally similar or identical to the first segmentation algorithm 104 of the workflow 100 of FIG. 1. For instance, the first segmentation algorithm 506 can be a semantic segmentation algorithm that is configured to generate a set of tooth identifier probabilities, where each tooth identifier probability represents a likelihood that a pixel of the first downsampled 2D image corresponds to a particular tooth identifier of a plurality of tooth identifiers for the patient's teeth. In some embodiments, the first segmentation algorithm 506 includes determining relative values for each combination of pixels and tooth identifiers, and the relative values can be transformed into a distribution of tooth identifier probabilities using another function, such as a softmax function. The tooth identifier probabilities can be represented as a first downsampled array (e.g., matrix) having the same dimensions as the first downsampled 2D image, and having k channels, where k is the number of possible tooth identifiers (e.g., k=33, including 32 tooth identifiers and 1 “background” identifier as described elsewhere herein).

The workflow 500 can also include performing a first upsampling 508 of the first downsampled array representing the tooth identifier probabilities. The first upsampling 508 can include upsampling the first downsampled array from the lower image resolution to the initial image resolution of the 2D image 502, thereby producing a first upsampled array representing the tooth identifier probabilities. In some embodiments, each of the k channels of the first downsampled array are upsampled back to the original image size of the 2D image 502 (e.g., 512 pixels by 512 pixels). However, the first downsampled array can be alternatively upsampled to any other image size. The first upsampling 508 can be performed using an interpolation technique, such as nearest neighbor interpolation, bilinear interpolation, bicubic interpolation, spline interpolation, etc., or any other resampling technique. In some embodiments, the first upsampling 508 is optional, such that the subsequent processes of the workflow 500 are performed on the first downsampled array instead of the first upsampled array.

Separate from the processing of the first downsampled 2D image, the workflow 500 can include performing a second downsampling 510 of the 2D image 502 to produce a second downsampled 2D image. The second downsampling 510 can be generally similar or identical to the first downsampling 504. For instance, the 2D image 502 can be downsampled from an initial image resolution to a lower image resolution. The 2D image 502 can be downsampled to a fixed size, a proportional size, or a proportional size with constraints using any suitable downsampling technique. In some embodiments, the first downsampled 2D image and the second downsampled 2D image have the same dimensions. Alternatively, the first downsampled 2D image and the second downsampled 2D image may have different dimensions. Further, in some embodiments, the second downsampling 510 is optional, such that the subsequent processes of the workflow 500 are performed on the initial 2D image 502 rather than the second downsampled 2D image.

The workflow 500 can also include inputting the second downsampled 2D image into a second segmentation algorithm 512. The second segmentation algorithm 512 can be generally similar or identical to the second segmentation algorithm 108 of the workflow 100 of FIG. 1. For instance, the second segmentation algorithm 512 can be an object instance segmentation algorithm that is configured to generate a set of tooth mask probabilities, where each tooth mask probability represents a likelihood that a pixel of the second downsampled 2D image is associated with a particular tooth mask of a plurality of tooth masks for the patient's teeth. The tooth mask probabilities can be represented as a second downsampled array having the same dimensions as the second downsampled 2D image, and having M channels, where M is the number of possible tooth masks.

The workflow 500 can also include performing a second upsampling 514 of the second downsampled array representing the tooth mask probabilities. The second upsampling 514 can include upsampling the second downsampled array from the lower image resolution to the initial image resolution of the 2D image 502, thereby producing a second upsampled array representing the tooth mask probabilities. In some embodiments, each of the M channels of the second downsampled array are upsampled back to the original size of the 2D image 502 (e.g., 512 pixels by 512 pixels). However, the second downsampled array can be alternatively upsampled to any other image size. The second upsampling 514 can be performed using an interpolation technique, such as nearest neighbor interpolation, bilinear interpolation, bicubic interpolation, spline interpolation, etc., or any other resampling technique. In some embodiments, the second upsampling 514 is optional, such that the subsequent processes of the workflow 500 are performed on the second downsampled array instead of the second upsampled array.

The workflow 500 can also include a combination process 516 for generating mask identifier probabilities 518 based on the tooth identifier probabilities and tooth mask probabilities. Each mask identifier probability 518 may represent a likelihood that a particular tooth mask of the plurality of tooth masks corresponds to a particular tooth identifier of the plurality of tooth identifiers. In some embodiments, the combination process 516 includes a series of mathematical operations, such as multiplying, summing, averaging, etc. In some embodiments, the combination process 516 is generally similar or identical to the workflow 400 of FIGS. 4A-4D. For instance, each channel (tooth mask) of the second upsampled array can be multiplied by the first upsampled array (representing tooth identifier probabilities), and can then be divided by the sum of the probabilities for that tooth mask to determine the mask identifier probabilities 518 for that tooth mask; this process may be repeated across all channels (tooth masks) of the second upsampled array to determine the mask identifier probabilities 518 for all tooth masks. The output of the combination process 516 can be a matrix of mask identifier probabilities 518, where each row of the matrix corresponds to a particular tooth mask (e.g., 1 to M), each column of the matrix corresponds to a particular tooth identifier (e.g., 1 to k), and each element of the matrix represents a likelihood that a particular tooth mask corresponds to a particular tooth identifier.

The workflow 500 can optionally include an adjustment process 520 for the mask identifier probabilities 518. In some embodiments, the adjustment workflow 520 includes modifying the mask identifier probabilities 518 based on a treatment plan 522. The treatment plan 522 can include the patient's medical data (e.g., medical history, dental scans), demographic data (e.g., age, gender, race/ethnicity), environmental data (e.g., water quality, diet), and/or anatomical structures of interest. The treatment plan 522 may include data (e.g., 3D digital models) providing information on the patient's teeth and/or teeth-like objects, such as missing teeth, supernumerary teeth, whether the patient has mixed dentition (e.g., a patient with both primary dentition and secondary/erupting dentition), virtual objects (e.g., eruption compensations, virtual pontics), etc. In some embodiments, modifying the mask identifier probabilities 518 based on the treatment plan 522 includes removing at least one of the mask identifier probabilities 518 to account for teeth that are known to be missing in the patient's dentition. For instance, referring again to FIG. 4D, if it is known from a treatment plan for the patient that the patient is missing a tooth having tooth identifier #2, then the entire column of mask identifier probabilities corresponding to the tooth identifier #2 can be removed (e.g., the matrix can be resized or the probability values in the column can be replaced with zeros). Alternatively or in combination, probability values from the column can be redistributed to other columns (e.g., columns corresponding to neighboring teeth only or columns corresponding to all remaining teeth), e.g., if the patient does not have tooth identifier #2, the likelihood that a tooth mask corresponds to tooth identifier #1 or tooth identifier #3 may increase. In other embodiments, however, the adjustment process 520 may be omitted, e.g., if the treatment plan 522 is not available.

Returning to FIG. 5, the workflow 500 can optionally include a reordering process 524 for the mask identifier probabilities 518. The reordering process 524 can be used to reorder (e.g., rearrange) the tooth masks and associated mask identifier probabilities 518 to reflect their relative position along a dental arch. In some embodiments, the reordering process 524 orders the tooth masks sequentially along a patient's dental arch (“arch order”). For instance, for an upper arch of a patient's dentition, arch order can start from the distalmost tooth on the right side (e.g., tooth #1) and end with the distalmost tooth on the left side (e.g., tooth #16). For a lower arch of a patient's dentition, arch order can start from the distalmost tooth on the left side (e.g., tooth #17) and end with the distalmost tooth on the right side (e.g., tooth #32). The reordering process 524 can include determining an expected value (also known as a “center of probability mass”) for each tooth mask. The expected value can be determined by multiplication (e.g., dot product multiplication) of the mask identifier probabilities for a given tooth mask with an enumerated list of all possible tooth identifiers. For instance, the first mask identifier probability for a given tooth mask can be multiplied by 1 (corresponding to tooth identifier #1), the second mask identifier probability for a given tooth mask can be multiplied by 2 (corresponding to tooth identifier #2), the third mask identifier probability for a given tooth mask can be multiplied by 3 (corresponding to tooth identifier #3), and so on. The multiplied mask identifier probabilities for the given tooth mask can be summed to determine the expected value of the tooth identifier for the tooth mask. This process can be repeated for all tooth masks, and the expected values across all tooth masks can be compared to each other. Based on the expected values, the tooth masks can be reordered in the matrix of mask identifier probabilities 518, e.g., based on a predetermined tooth identifier ordering (such as from tooth identifier #1 to #32). An example of this process is illustrated with respect to FIGS. 4E and 4F below.

FIGS. 4E and 4F illustrate an example reordering workflow continuing from the workflow of FIGS. 4A-4D, in accordance with embodiments of the present technology. Referring first to FIG. 4E, each column of the single matrix of mask identifier probabilities MI can be multiplied by a respective multiplier. These multipliers may be based on the numbering of the tooth identifiers. For instance, if there are 33 tooth identifiers, each column can be multiplied by a multiplier selected from the numbers 1-33. As shown, the first column of the matrix MI has been multiplied by a multiplier of 1 (corresponding to tooth identifier #1), the second column of the matrix MI has been multiplied by a multiplier of 2 (corresponding to tooth identifier #2), and the third column of the matrix MI has been multiplied by a multiplier of 3 (corresponding to tooth identifier #3). The products in each row can be summed to produce an expected value for each tooth mask. For instance, tooth mask A has an expected value of 2.2, tooth mask B has an expected value of 1.63, and tooth mask C has an expected value of 2.47.

The tooth masks (rows) can be reordered based on the expected values (e.g., from smallest to largest, or any other suitable order) to produce a reordered matrix RMI. The reordered matrix RMI is shown in FIG. 4F. As shown, tooth mask B has now been moved to the first row of the matrix RMI, since the expected value for tooth mask B is the lowest. Tooth mask A has been moved to the second row, since the expected value of tooth mask A is higher than the expected value for tooth mask B but lower than the expected value of tooth mask C. Tooth mask C has remained in the same row, since the expected value of tooth mask C is the greatest. By reordering along the expected value, the confidence of the order may be increased because the probabilities of the first segmentation algorithm (e.g., semantic segmentation) may better preserve the tooth order in the dental arch relative to the second segmentation algorithm (e.g., object instance segmentation).

Returning to FIG. 5, the workflow 500 can continue with inputting the reordered mask identifier probabilities 518 into a maximum likelihood algorithm 526 to determine tooth assignments 528 for the 2D image 502. The tooth assignments 528 can include a tooth mask (representing the boundaries of the tooth) and a tooth identifier for each tooth (representing the identity of the tooth) in the 2D image 502. In some embodiments, the maximum likelihood algorithm 526 is generally similar or identical to the maximum likelihood algorithm described in connection with the workflow 100 of FIG. 1. For instance, the maximum likelihood algorithm may be configured to determine the tooth assignments 528 for the 2D image 502 based on the reordered mask identifier probabilities 518. For example, the order may dictate the tooth identifiers of the tooth assignments 528 (e.g., each successive mask being associated with a successive tooth identifier). Referencing FIG. 4F, based on the new order of the tooth masks in the reordered matrix RMI, tooth mask B may be determined to correspond to tooth identifier #1, tooth mask A to tooth identifier #2, and tooth mask C to tooth identifier #3. Thus, although looking at the individual tooth identifier probabilities of tooth masks A and C (i.e., 0.5 and 0.6 for tooth identifier #3, respectively) would have resulted in a determination that they both correspond to tooth identifier #3, the reordering process is able to distinguish between them and determine the optimal correspondence.

Returning to FIG. 5, in some embodiments, the maximum likelihood algorithm is configured to determine the tooth assignments by evaluating the distribution of mask identifier probabilities in the reordered mask identifier probabilities 418. In some embodiments, the maximum likelihood algorithm 526 evaluates the patient's upper and lower jaws separately, e.g., tooth identifiers #1-16 may be evaluated separately from tooth identifiers #17-32 when using the universal numbering system. As previously noted, further details of a maximum likelihood algorithm are described in U.S. Pat. No. 11,357,598, the disclosure of which is incorporated by reference herein in its entirety.

Optionally, the workflow 500 may also include outputting the tooth assignments 528, e.g., on a display. For instance, the tooth assignments 528 can be superimposed on the patient's teeth in the 2D image 502, e.g., as shown in FIG. 2C. Alternatively or in combination, the tooth assignments 528 can be stored as a tooth segmentation mask corresponding to the 2D image 502. The tooth assignments 528 and/or the 2D image 502 can be used in dental monitoring, treatment planning, and/or the construction of dental models, e.g., as described elsewhere herein.

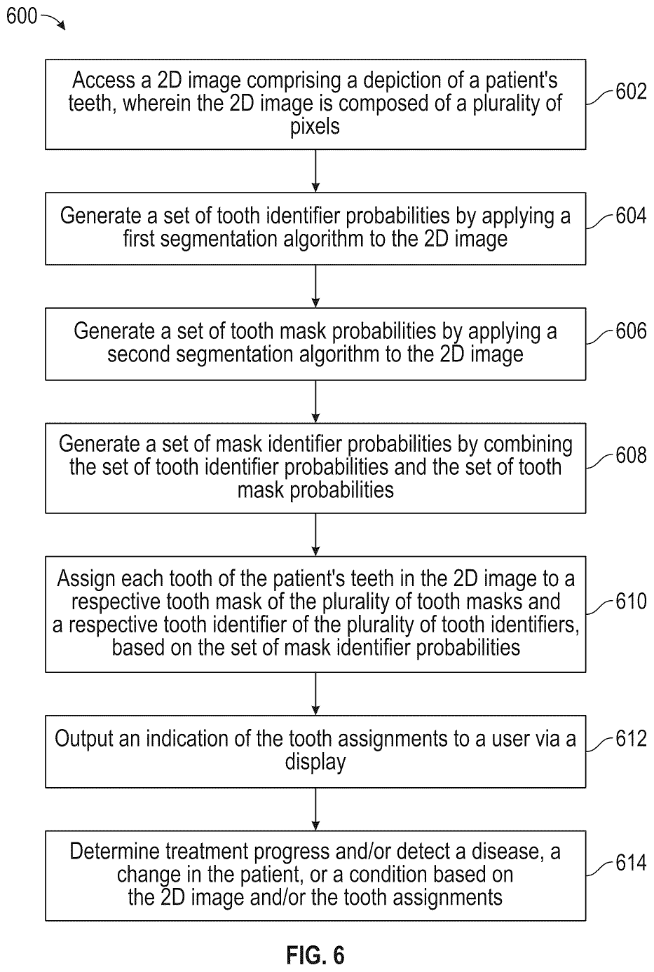

FIG. 6 is a flow diagram illustrating a method 600 for identifying teeth in a patient image, in accordance with embodiments of the present technology. In some embodiments, some or all of the processes of the method 600 are implemented as computer-readable instructions (e.g., program code) that are configured to be executed by one or more processors of a computing device (e.g., a mobile device, laptop, personal computer, workstation, remote server). In some embodiments, the computing device is part of a virtual dental care system as described in, e.g., U.S. Patent Application Publication No. 2022/0023003. The method 600 can be utilized and/or combined with any of the other workflows and/or methods described herein, such as the workflow 100 of FIG. 1 and/or the workflow 500 of FIG. 5.

The method 600 can begin at block 602 with accessing a 2D image comprising a depiction of a patient's teeth. The 2D image can be generally similar or identical to any of the 2D images described herein, such as the 2D image 102 of the workflow 100 of FIG. 1, the 2D image 200 of FIG. 2, and/or the 2D image 502 of the workflow 500 of FIG. 5. For instance, the 2D image can be a photograph of the patient's face, and the 2D image can be composed of a plurality of pixels.

The method 600 can continue at block 604 with generating a set of tooth identifier probabilities by applying a first segmentation algorithm to the 2D image (e.g., a semantic segmentation algorithm). Each tooth identifier probability may represent a likelihood that a given pixel of the 2D image corresponds to a particular tooth identifier of a plurality of tooth identifiers. Tooth identifiers can take any form, such as a label, tag, designation, etc. that conveys a particular tooth's identity. The plurality of tooth identifiers for the patient may be determined based on a dental notation system and/or based on a clinician's assessment, e.g., using previous dental scans and/or medical data. The first segmentation algorithm can be generally similar or identical to the first segmentation algorithm 104 of the workflow 100 of FIG. 1 and/or the first segmentation algorithm 506 of the workflow 500 of FIG. 5. For instance, the first segmentation algorithm can receive the 2D image and generate the set of tooth identifier probabilities by evaluating each pixel against each possible tooth identifier. In some embodiments, a high tooth identifier probability indicates that a pixel likely corresponds to a particular tooth identifier, whereas a low tooth identifier probability indicates that a pixel does not likely correspond to the particular tooth identifier.

The method 600 can continue at block 606 with generating a set of tooth mask probabilities by applying a second segmentation algorithm to the 2D image (e.g., an object instance segmentation algorithm). Each tooth mask probability may represent a likelihood that a given pixel is associated with a particular tooth mask of a plurality of tooth masks. Tooth masks can include regions and/or contour lines defining tooth boundaries. In some embodiments, the second segmentation algorithm can determine the plurality of tooth masks based on the 2D image. The second segmentation algorithm can be generally similar or identical to the second segmentation algorithm 108 of the workflow 100 and/or the second segmentation algorithm 512 of the workflow 500 of FIG. 5. For instance, the second segmentation algorithm can receive the 2D image and generate the set of tooth mask probabilities by evaluating each pixel against each possible tooth mask. In some embodiments, a high tooth mask probability indicates that a pixel likely corresponds to a particular tooth mask, whereas a low tooth mask probability indicates that a pixel does not likely correspond to the particular tooth mask.

The method 600 can continue at block 608 with generating a set of mask identifier probabilities by combining the set of tooth identifier probabilities and the set of tooth mask probabilities. Each mask identifier probability may represent a likelihood that a particular tooth mask of the plurality of tooth masks corresponds to a particular tooth identifier of the plurality of tooth identifiers. In some embodiments, the combination includes a series of mathematical operations, such as multiplying, summing, averaging, etc. An example of a workflow for generating mask identifier probabilities is described above, e.g., in connection with FIGS. 4A-4E. Optionally, the mask identifier probabilities may undergo adjustments based on treatment plan data and/or reordering, e.g., as described above in connection with FIGS. 4E, 4F, and 5.

The method 600 can continue at block 610 with assigning each tooth of the patient's teeth in the 2D image to a respective tooth mask of the plurality of tooth masks and a respective tooth identifier of the plurality of tooth identifiers, based on the set of mask identifier probabilities. In some embodiments, the tooth assignments include a tooth mask (representing the boundaries of the tooth) and a tooth identifier for each tooth (representing the identity of the tooth) in the 2D image. Stated differently, each tooth in the 2D image can be assigned a tooth mask selected from the plurality of tooth masks and assigned a tooth identifier selected from the plurality of tooth identifiers, where the assignment of the tooth masks and tooth identifiers have a high or maximum likelihood of being correct, based on the mask identifier probabilities. The tooth assignments can be determined at least in part by a maximum likelihood algorithm, e.g., the maximum likelihood algorithm 526 of the workflow 500 of FIG. 5.

The method 600 can continue at block 612 with outputting an indication of the tooth assignments to a user via a display. For instance, the tooth assignments can be displayed on a monitor or screen that is associated with a computing device (e.g., a mobile device, personal computer, laptop, tablet, workstation). The computing device can be part of a computing system (e.g., a virtual dental care system) that includes one or more local client devices (e.g., patient devices and/or clinician devices) communicably coupled to a remote server (e.g., of a dental appliance manufacturer and/or a treatment monitoring service provider) via a communications network. In some embodiments, the computing device used to display the indication of the tooth assignments is the same as the computing device used to perform the other processes of the method 600, e.g., all of the processes of the method 600 are performed by a local client device. In other embodiments, the computing device used to display the indication of the tooth assignments is different than the computing device used to perform the other processes of the method 600, e.g., indication of the tooth assignments is displayed by a local client device and the other processes are performed by a remote server.

The tooth assignments can be displayed as a graphical overlay over the 2D image. For instance, the tooth assignments can include tooth masks and tooth identifiers directly overlaid on the patient's teeth in the 2D image. Alternatively or in combination, the tooth assignments can be displayed in other formats (e.g., in an array, grid, list, text, graphics, etc.).

The method 600 can continue at block 614 with determining treatment progress and/or detecting a disease, a change in the patient, or a condition based on the 2D image and/or the tooth assignments. In some embodiments, the 2D image and the tooth assignments are sent to the patient's clinician. The clinician may assess the patient's treatment progress and/or dental condition based on the 2D image and the tooth assignments. For instance, the clinician may determine whether the patient's dentition is satisfactorily progressing according to a treatment stage of a treatment plan configured to reposition the patient's teeth. As another example, the clinician may diagnose the patient with an oral disease or condition based on the 2D image and the tooth assignments.

Alternatively or in addition, the treatment evaluation and/or monitoring may be completed automatically. For instance, the 2D image and the tooth assignments may be inputted (e.g., uploaded) into a dental evaluation and/or monitoring algorithm, and the dental evaluation and/or monitoring algorithm may be configured to assess the patient's dental condition and predict outcomes of the dental treatment based on the patient's current state. Optionally, the dental evaluation and/or monitoring algorithm may compare the patient's current state, as indicated by the 2D image and the tooth assignments, with a previous patient state, e.g., as indicated by a previous 2D image and previous tooth assignments. Based on the comparison, the dental evaluation algorithm may provide recommendations to the clinician regarding the dental treatment.

For example, the method 600 may include detecting changes in the size, shape, or position of a tooth mask, which may signal tooth decay, gum recession, or tooth movement due to periodontal disease. If the contour or boundary of a tooth mask becomes irregular, it could suggest the presence of cavities, fractures, or enamel erosion. Additionally, the method 600 may include analyzing the spatial relationships between neighboring teeth. The automated and consistent nature of the method ensures that even gradual or minor changes, which might be overlooked during manual reviews, are flagged for further evaluation. In the context of ongoing treatment, such as orthodontic interventions or restorative procedures, the system can track the progress by observing whether the tooth assignments and their spatial configuration align with expected outcomes. Deviations from the planned tooth movement or unexpected morphological changes could prompt early intervention, adjustment of the treatment plan, or additional diagnostics. Thus, the methods and systems disclosed herein allow for early detection, continuous treatment monitoring, and proactive management of dental diseases and conditions based on objective data (e.g., images of teeth).

The method 600 illustrated in FIG. 6 can be modified in many different ways. For example, although the above processes of the method 600 are described with respect to a single 2D image, the method 600 can be used to sequentially or concurrently identify teeth in any suitable number of images. As another example, the ordering of the processes shown in FIG. 6 can be varied, or some processes may be performed concurrently, e.g., the processes of blocks 604 and 606 may occur at the same. In some embodiments, the method 600 may be performed on a remote server. For example, a patient or doctor device (e.g., a smartphone) may be used to capture a 2D image, and this 2D image may be transmitted to the remote server (e.g., via a smartphone application). The remote server may then execute any of the processes of blocks 602-614. In other embodiments, the method 600 may be entirely performed on a local client device (e.g., a mobile device, a personal computer). In some embodiments, some of the steps may be performed on a remote server, and some of the steps may be performed on a local client device. Some of the processes of the method 600 can be omitted (e.g., the process of block 612 and/or the process of block 614) and/or the method 600 can include processes not shown in FIG. 6 (e.g., administering a treatment plan to address a detected disease, change in the patient, or condition; generating a modified dental treatment plan based on the patient's treatment progress and administering the modified dental treatment plan to the patient).

Although certain embodiments of the present technology are described with respect to workflows and methods that use a first segmentation algorithm to generate tooth identifier probabilities and a second segmentation algorithm to generate tooth mask probabilities, this is not intended to be limiting. In other embodiments, the workflows and methods herein can use a single segmentation algorithm, such as a panoptic segmentation algorithm that performs both semantic segmentation and object instance segmentation concurrently. The input to the panoptic segmentation algorithm can be a 2D image of a patient's teeth, and the output of the panoptic segmentation algorithm can include a plurality of tooth masks and a set of mask identifier probabilities for the tooth masks. The tooth masks and mask identifier probabilities can be used to determine a set of tooth assignments for the 2D image, as described elsewhere herein.

In some embodiments, the present technology provides methods for tooth identification using a single segmentation algorithm that generates tooth masks and tooth identifiers from a 2D image of a patient's teeth, where the single segmentation algorithm includes mechanisms that take contextual information into consideration, such as the spatial relationships between teeth, thereby improving the accuracy of the resulting tooth assignments. For instance, rather than relying solely upon the features of a single tooth of interest when determining the tooth mask and tooth identifier for that tooth, the segmentation algorithm can also consider the features of other teeth that are visible in the image, such as one or more teeth proximate to the tooth of interest (e.g., neighboring teeth that are immediately adjacent to the tooth of interest).

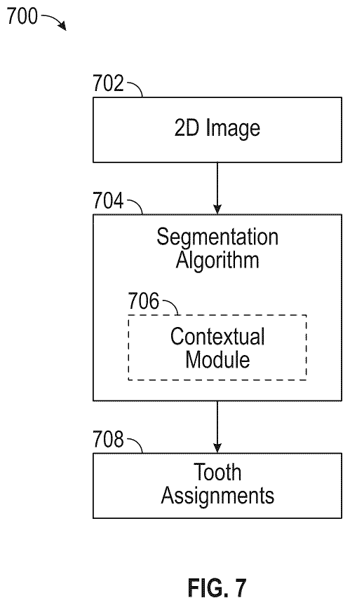

FIG. 7 is a block diagram illustrating a representative example of a workflow 700 for identifying teeth in a patient image, in accordance with embodiments of the present technology. In some embodiments, some or all of the processes described with respect to the workflow 700 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003. The workflow 700 can be utilized and/or combined with any of the other workflows and/or methods described herein, such as the workflow 100 of FIG. 1. For instance, techniques described in connection with the workflow 700 may be applicable to the workflow 100 of FIG. 1, and vice versa.

The workflow 700 can include accessing a 2D image 702 including a depiction of the patient's teeth. The 2D image 702 can be generally similar or identical to any of the 2D images described herein, such as the 2D image 102 of the workflow 100 of FIG. 1 or the 2D image 200 of FIG. 2A. For instance, the 2D image 702 can be a photograph of the patient's face (e.g., an intraoral or extraoral photograph), and the 2D image 702 can be composed of a plurality of pixels.

The workflow 700 can also include applying a segmentation algorithm 704 to the 2D image 702. The segmentation algorithm 704 can be generally similar to any of the segmentation algorithms described herein, such as the first segmentation algorithm 104 and/or the second segmentation algorithm 108 of the workflow 100 of FIG. 1. For instance, the segmentation algorithm 704 can be an object instance segmentation algorithm, a semantic segmentation algorithm, or a combination thereof (e.g., a panoptic segmentation algorithm). In some embodiments, the segmentation algorithm 704 is configured to determine a tooth mask and a tooth identifier for each tooth of the patient's teeth in the 2D image, where the tooth mask represents the boundary of the tooth and the tooth identifier represents an identity of the tooth, e.g., as described elsewhere herein.

In some embodiments, the segmentation algorithm 704 includes a contextual module 706. The contextual module 706 can be configured to incorporate contextual information into the determination of the tooth masks and tooth identifiers, such as the relative positioning of the teeth and/or other inter-tooth relationships. For instance, when determining a tooth mask and tooth identifier for a particular tooth, the contextual module 706 can consider contextual information of one or more other teeth that are visible in the 2D image 702, such as local contextual information corresponding to features of one or more teeth that are proximate to (e.g., immediately adjacent to) the tooth of interest, and/or global contextual information corresponding to features of teeth that may not necessarily be proximate to the tooth of interest. The contextual information may include any feature that is relevant to tooth identification, such as the size, shape, relative spatial location, etc., of a tooth.

In some embodiments, the contextual module 706 includes an attention mechanism. An attention mechanism can operate on a sequence of inputs, such that the context of each input in the sequence (e.g., features of other inputs in the sequence) is considered in determining the output. An attention mechanism can be configured to assign attention weights for each input feature relative to the other input features, such that a model prioritizes, or pays attention to, the most relevant features for a given task. An attention mechanism can operate similarly to a database lookup system. For instance, an attention mechanism can be configured to map a query and a set of key-value pairs to an output. The output may be computed as a weighted sum of the values, where the weight assigned to each value is computed based on the query and the corresponding key. In the context of tooth identification, an attention mechanism may be configured to identify and prioritize features relevant to tooth identification, such as features associated with other teeth that are proximate to a tooth of interest (e.g., shapes, sizes, and/or locations of the other teeth). In some embodiments, the attention mechanism is a self-attention mechanism, such as a multi-head self-attention mechanism.

For example, in identifying a patient's upper right canine tooth in a 2D intraoral image, a segmentation algorithm enhanced with an attention mechanism may first identify the approximate region of the canine tooth. Instead of focusing solely on the features within this region (such as shape and size), the attention mechanism may also examine neighboring teeth (e.g., the adjacent premolar and incisor). The attention mechanism may analyze the spatial relationships and characteristics of these neighboring teeth. For example, it may compare the size and contour of the canine with those of the neighboring premolar and incisor, taking into account the typical arrangement and spacing found in dental anatomy. For example, it may prioritize features such as the relative position (the canine is usually between the incisor and premolar), the unique pointed shape of the canine, and the expected size of the canine compared to its neighbors. As a result, the attention mechanism helps the segmentation algorithm avoid misidentifying the canine as a premolar or incisor, and this may be especially advantageous in certain cases where, for example, the image is blurry or teeth overlap. By leveraging context from proximate teeth, the algorithm may produce more accurate tooth masks and identifiers, ultimately improving the reliability of automated dental analysis and treatment planning.

The contextual module 706 can be incorporated into the segmentation algorithm 704 in any suitable manner. For example, the segmentation algorithm 704 can be configured to identify a plurality of regions in the 2D image, each region corresponding to an estimated location of a tooth of the patient's teeth in the 2D image. The plurality of regions can be input into the contextual module 706 (e.g., attention mechanism) that is configured to determine a tooth mask and a tooth identifier for each tooth based on the regions. For example, the tooth mask and tooth identifier for each tooth may be based on the features of the region corresponding to the estimated location of that particular tooth, as well as the features of the regions corresponding to estimated locations of the one or more teeth proximate to the tooth. Stated differently, the contextual module 706 may be configured to determine the tooth mask and tooth identifier for each tooth based at least in part on contextual information from other teeth in the 2D image 702.

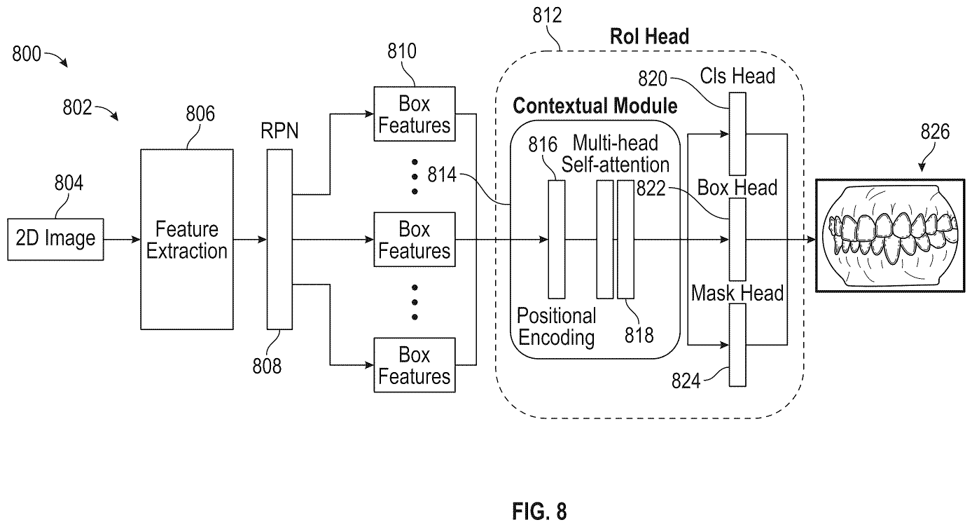

FIG. 8 is a block diagram illustrating a representative example of a segmentation algorithm 800 including a contextual module 814, in accordance with embodiments of the present technology. The segmentation algorithm 800 can be used in a tooth identification workflow, such as the workflow 700 of FIG. 7, to identify teeth in a patient image. The segmentation algorithm 800 can be implemented across any desired software and/or hardware components by any of the systems and devices described herein.

In some embodiments, the segmentation algorithm 800 includes a neural network 802. The neural network 802 can be configured to receive a 2D image 804 of a patient's teeth, such as the 2D image 702 of the workflow 700 of FIG. 7. The neural network 802 can be a convolutional neural network (CNN). In some embodiments, the CNN is or includes a Mask R-CNN algorithm that has been modified to incorporate a contextual module 814. Additionally or alternatively, the neural network 802 may be or include a Faster R-CNN algorithm, PolarMask++ algorithm, YOLACT algorithm, YOLO algorithm, YOLOv8 algorithm, Single-Shot Instance Segmentation with Affinity Pyramid (SSAP) algorithm, BlendMask algorithm, CondInst algorithm, SOLO algorithm, MeINST algorithm, CenterMask algorithm, DETR algorithm, RetinaNet algorithm, Mask2Former algorithm, or any other suitable algorithm that has been modified to incorporate a contextual module 814.

The neural network 802 can be configured to identify a boundary for each of the patient's teeth in the 2D image 804. For instance, the neural network 802 can include one or more feature extraction layers 806 configured to extract features from the 2D image, such as a feature pyramid network (FPN). The neural network 802 can further include a region proposal network (RPN) 808 configured to generate the plurality of regions based on the extracted features. In some embodiments, the RPN 808 generates proposals of regions of interest in the 2D image, each proposal representing a candidate object bounding box that defines the estimated boundaries of a tooth in the 2D image, where each object bounding box is associated with a respective set of box features 810.

The neural network 802 can further be configured to determine a tooth mask and a tooth identifier for each tooth of the patient's teeth in the 2D image, based on the plurality of regions. The determination can incorporate local and/or global contextual information to improve the accuracy of tooth identification, as described elsewhere herein. For instance, the tooth mask and tooth identifier for each tooth may be based on the features of the region corresponding to the estimated location of that particular tooth, as well as the features of the regions corresponding to estimated locations of the one or more teeth proximate to the tooth.

In the illustrated embodiment, for example, the neural network 802 includes a Region of Interest (ROI) head 812 that is configured to evaluate the candidate object bounding boxes and/or box features 810 to determine the tooth masks and tooth identifiers. In some embodiments, the ROI head 812 of the neural network 802 includes the contextual module 814. In some embodiments, the contextual module 814 can have an architecture similar to or the same as a transformer architecture. The contextual module 814 may include a box positional encoder 816 and/or one or more self-attention layers 818. The box positional encoder 816 may approximate and/or specify positional information associated with the candidate object bounding boxes. For instance, the box positional encoder 816 may specify a positional sequence for the candidate object bounding boxes, e.g., where the candidate object bounding boxes are located relative to one another. The one or more self-attention layers 818 may include multi-head self-attention layers configured to capture inter-proposal relationships based on the candidate object bounding boxes and the positional sequence. Accordingly, the contextual module 814 may be configured to, for each candidate object bounding box, provide contextual cues from surrounding candidate object bounding boxes and their relative spatial arrangement, thereby leveraging spatial information for tooth identification.

In some embodiments, the ROI head 812 can further include modules for classification. For example, it may include a classification head 820, a box head 822, and a mask head 824 that receive and process the output from the contextual module 814 to generate tooth assignments 826 for the teeth in the 2D image. Specifically, the classification head 820 can determine tooth identifiers for each tooth, the mask head 824 can determine tooth masks for each tooth, and the box head 822 can determine refined object bounding boxes for each tooth. The tooth assignments 826 can include the tooth identifiers produced by the classification head 820 and the tooth masks produced by the mask head 824. In some embodiments, one or more of these heads may be omitted (e.g., the box head 822 may be optional and may be omitted).

The neural network 802 can be trained using training data including input 2D images and corresponding tooth assignments. In some embodiments, training the neural network 802 includes partitioning the training data, e.g., using a train-test split, k-fold cross-validation, and/or other forms of data partitioning. For instance, the neural network 802 can be trained using the training set, such that the neural network 802 learns how to predict tooth assignments from the training set. Thereafter, the neural network 802 can be tested on the test set. A loss (e.g., error) can be computed based on the test set, such as by evaluating the difference between the known tooth assignments and the predicted tooth assignments, and the neural network 802 can be retrained accordingly. In some embodiments, retraining the neural network 802 includes modifying one or more parameters and/or hyperparameters of the neural network 802. The modifiable parameters can include the number of layers, number of “neurons” per layer, the type of cell, output dropout, state dropout, variational dropout, learning rate, decay factor, beta coefficient, maximum number of iterations, etc. Once the loss is below a predetermined error tolerance, the neural network 802 is considered trained and can be configured to receive new 2D images and predict tooth assignments based on the new data.

Returning to FIG. 7, the workflow 700 can further include determining tooth assignments 708 for the 2D image 702. In some embodiments, the tooth assignments 708 include a tooth mask (representing the boundaries of the tooth) and a tooth identifier for each tooth (representing the identity of the tooth) in the 2D image 702 that were determined using the segmentation algorithm 704. Optionally, the workflow 700 can include outputting the tooth assignments 708, e.g., on a display. For instance, the tooth assignments 708 may be superimposed on the patient's teeth in the 2D image 702, e.g., as shown in FIG. 2C. Alternatively or in combination, the tooth assignments 708 can be stored as a tooth segmentation mask corresponding to the 2D image 702. The tooth assignments 708 and/or the 2D image 702 can be used in dental monitoring, treatment planning, and/or the construction of dental models, e.g., as described elsewhere herein.

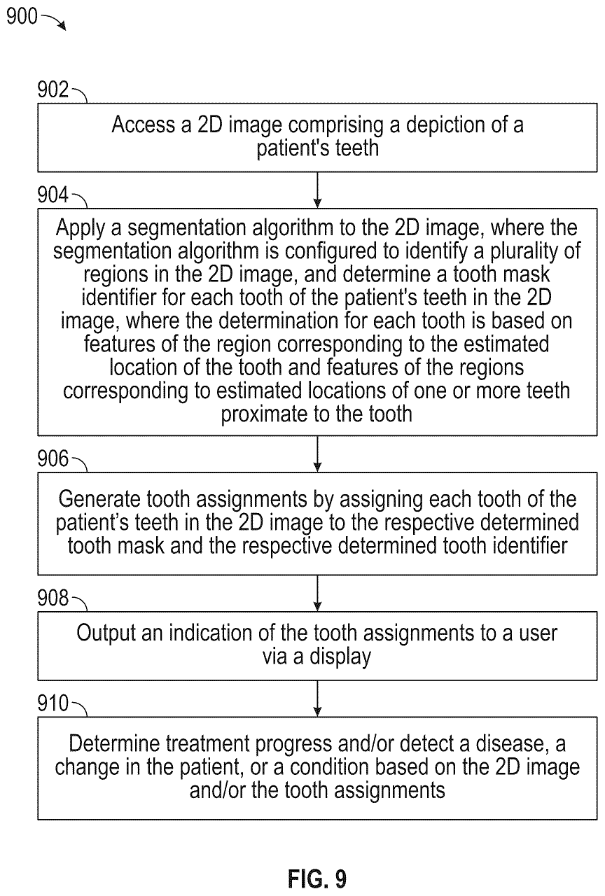

FIG. 9 is a flow diagram illustrating a method 900 for identifying teeth in a patient image, in accordance with embodiments of the present technology. In some embodiments, some or all of the processes of the method 900 are implemented as computer-readable instructions (e.g., program code) that are configured to be executed by one or more processors of a computing device (e.g., a mobile device, laptop, personal computer, workstation, remote server). In some embodiments, the computing device is part of a virtual dental care system as described in, e.g., U.S. Patent Application Publication No. 2022/0023003. The method 900 can be utilized and/or combined with any of the other workflows and/or methods described herein, such as the workflow 700 of FIG. 7.

The method 900 can begin at block 902 with accessing a 2D image comprising a depiction of a patient's teeth. The 2D image can be generally similar or identical to any of the 2D images described herein, such as the 2D image 102 of the workflow 100 of FIG. 1, the 2D image 200 of FIG. 2, and/or the 2D image 702 of the workflow 700 of FIG. 7. For instance, the 2D image can be a photograph of the patient's face, and the 2D image can be composed of a plurality of pixels.

The method 900 can continue at block 904 with applying a segmentation algorithm to the 2D image. The segmentation algorithm can be generally similar to any of the segmentation algorithms described herein, such as the first segmentation algorithm 104 and/or the second segmentation algorithm 108 of the workflow 100 of FIG. 1, and/or the segmentation algorithm 800 of FIG. 8. For instance, the segmentation algorithm can be object instance segmentation algorithm, a semantic segmentation algorithm, or a combination thereof (e.g., a panoptic segmentation algorithm). In some embodiments, the segmentation algorithm is configured to determine a tooth mask and a tooth identifier for each tooth of the patient's teeth in the 2D image, where the tooth mask represents the boundary of the tooth and the tooth identifier represents an identity of the tooth, e.g., as described elsewhere herein.

In some embodiments, the segmentation algorithm includes a contextual module. The contextual module can be the same or generally similar to the contextual module 706 of the segmentation algorithm 704 of the workflow 700 of FIG. 7. For instance, the contextual module may be configured to incorporate contextual information into the determination of the tooth masks and tooth identifiers, such as the relative positioning of the teeth and/or other inter-tooth relationships. Contextual information may include local contextual information corresponding to features of one or more teeth that are proximate to (e.g., immediately adjacent to) the tooth of interest, and/or global contextual information corresponding to features of teeth that may not necessarily be proximate to the tooth of interest. In some embodiments, the determination of tooth mask identifiers for each tooth is based on features of the region corresponding to the estimated location of the tooth and features of the regions corresponding to estimated locations of one or more tooth proximate to the tooth. The contextual information may include any feature that is relevant to tooth identification, such as the size, shape, relative spatial location, etc., of a tooth. In some embodiments, the contextual module includes an attention mechanism, such as a multi-head self-attention mechanism.

The method 900 can continue at block 906 with generating tooth assignments by assigning each tooth of the patient's teeth in the 2D image to the respective determined tooth mask and the respective determined tooth identifier.

The method 900 can continue at block 908 with outputting an indication of the tooth assignments to a user via a display. The processes of block 908 can be the same as or generally similar to the processes of block 612 of the method 600 of FIG. 6. For instance, the tooth assignments can be displayed on a monitor or screen that is associated with a computing device (e.g., a mobile device, personal computer, laptop, tablet, workstation). The computing device can be part of a computing system (e.g., a virtual dental care system) that includes one or more local client devices (e.g., patient devices and/or clinician devices) communicably coupled to a remote server (e.g., of a dental appliance manufacturer and/or a treatment monitoring service provider) via a communications network. The tooth assignments can be displayed as a graphical overlay over the 2D image. For instance, the tooth assignments can include tooth masks and tooth identifiers directly overlaid on the patient's teeth in the 2D image.

The method 900 can continue at block 910 with determining treatment progress and/or detecting a disease, a change in the patient, or a condition based on the 2D image and/or the tooth assignments. The processes of block 910 can be the same as or generally similar to the processes of block 614 of the method 600 of FIG. 6. For instance, the 2D image and the tooth assignments may be sent to the patient's clinician, and the clinician may assess the patient's treatment progress and/or dental condition based on the 2D image and the tooth assignments. Alternatively or in addition, the treatment evaluation and/or monitoring may be completed automatically.

For example, the method 900 can include detecting changes in the size, shape, or position of a tooth mask, which may signal tooth decay, gum recession, or tooth movement due to periodontal disease. If the contour or boundary of a tooth mask becomes irregular, it could suggest the presence of cavities, fractures, or enamel erosion. Additionally, the method 900 can include analyzing the spatial relationships between neighboring teeth. The automated and consistent nature of the method ensures that even gradual or minor changes, which might be overlooked during manual reviews, are flagged for further evaluation. In the context of ongoing treatment, such as orthodontic interventions or restorative procedures, the system can track the progress by observing whether the tooth assignments and their spatial configuration align with expected outcomes. Deviations from the planned tooth movement or unexpected morphological changes could prompt early intervention, adjustment of the treatment plan, or additional diagnostics. Thus, the methods and systems disclosed herein allow for early detection, continuous treatment monitoring, and proactive management of dental diseases and conditions based on objective data (e.g., images of teeth).

The method 900 illustrated in FIG. 9 can be modified in many different ways. For example, although the above processes of the method 900 are described with respect to a single 2D image, the method 900 can be used to sequentially or concurrently identify teeth in any suitable number of images. As another example, the ordering of the processes shown in FIG. 9 can be varied, or some processes may be performed concurrently, e.g., the processes of blocks 904 and 906 may occur at the same. In some embodiments, the method 900 may be performed on a remote server. For example, a patient or doctor device (e.g., a smartphone) may be used to capture a 2D image, and this 2D image may be transmitted to the remote server (e.g., via a smartphone application). The remote server may then execute any of the processes of blocks 902-910. In other embodiments, the method 900 may be entirely performed on a local client device (e.g., a mobile device, a personal computer). In some embodiments, some of the steps may be performed on a remote server, and some of the steps may be performed on a local client device. Some of the processes of the method 900 can be omitted (e.g., the process of block 908 and/or the process of block 910) and/or the method 900 can include processes not shown in FIG. 9 (e.g., administering a treatment plan to address a detected disease, change in the patient, or condition; generating a modified dental treatment plan based on the patient's treatment progress and administering the modified dental treatment plan to the patient).

In some embodiments, the present technology provides methods for tooth identification using a plurality of algorithms that operate in series to generate tooth masks and tooth identifiers from a 2D image of a patient's teeth. For instance, the plurality of algorithms can include a first algorithm (e.g., a segmentation algorithm) that generates tooth masks and tooth identifiers from a 2D image. The tooth masks and tooth identifiers can be provided to a second algorithm that uses contextual information to revise the tooth masks and/or tooth identifiers as appropriate. For example, the second algorithm can be a sequence processing algorithm (e.g., an RNN) that modifies the tooth identifier assigned to each tooth mask as appropriate to ensure that the resulting ordering of the tooth identifiers is consistent and anatomically plausible.

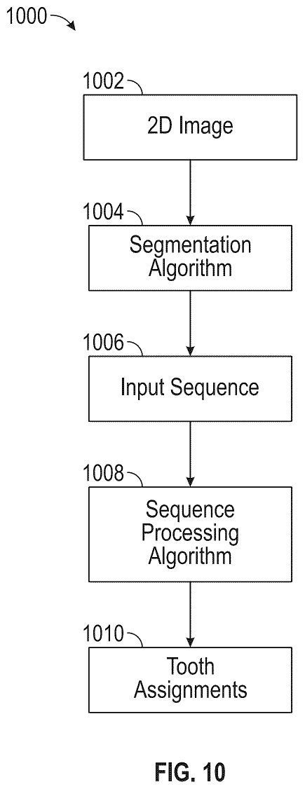

FIG. 10 is a block diagram illustrating a representative example of a workflow 1000 for identifying teeth in a patient image, in accordance with embodiments of the present technology. In some embodiments, some or all of the processes described with respect to the workflow 1000 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003. The workflow 1000 can be utilized and/or combined with any of the other workflows and/or methods described herein, such as the workflow 100 of FIG. 1 and/or the workflow 700 of FIG. 7. For instance, techniques described in connection with the workflow 1000 may be applicable to the workflow 100 of FIG. 1, and vice versa.

The workflow 1000 can include accessing a 2D image 1002 including a depiction of the patient's teeth. The 2D image 1002 can be generally similar or identical to any of the 2D images described herein, such as the 2D image 102 of the workflow 100 of FIG. 1 or the 2D image 200 of FIG. 2A. For instance, the 2D image 1002 can be a photograph of the patient's face (e.g., an intraoral or extraoral photograph), and the 2D image 1002 can be composed of a plurality of pixels.

The workflow 1000 can also include applying a segmentation algorithm 1004 to the 2D image 1002. The segmentation algorithm 1004 can be generally similar to any of the segmentation algorithms described herein, such as the first segmentation algorithm 104 and/or the second segmentation algorithm 108 of the workflow 100 of FIG. 1, and/or the segmentation algorithm 800 of FIG. 8. For instance, the segmentation algorithm 1004 can be an object instance segmentation algorithm, a semantic segmentation algorithm, or a combination thereof (e.g., a panoptic segmentation algorithm). In some embodiments, the segmentation algorithm 1004 is configured to determine a tooth mask and a first tooth identifier for each tooth of the patient's teeth in the 2D image, where the tooth mask represents the boundary of the tooth and the first tooth identifier represents an identity of the tooth, e.g., as described elsewhere herein.

In some embodiments, the workflow 1000 further includes generating an input sequence 1006 based on the tooth masks for the patient's teeth. The input sequence 1006 can include the tooth masks and/or can include features extracted from the tooth masks. For example, the features can include the relative location of the tooth mask centroid relative to a reference location (e.g., the mouth center in the associated 2D image), the contour edge length of the tooth mask, the contour width of the tooth mask, the contour height of the tooth mask, sampled contour points in the tooth mask (e.g., cusps, grooves), the size of the tooth (e.g., as defined by r=\sqrt{a/π}, where a is the area of the tooth mask), etc. The tooth masks and/or extracted features may be ordered in the input sequence 1006 based on the first tooth identifiers (e.g., in ascending or descending order of the first tooth identifiers). The ordering of the tooth masks and/or extracted features in the input sequence 1006 can represent the estimated spatial relationships of the corresponding teeth, e.g., tooth masks that have consecutive first tooth identifiers are placed next to each other in the input sequence 1006 and represent neighboring teeth in the patient's mouth.

The workflow 1000 can further include applying a sequence processing algorithm 1008 to the input sequence 1006. The sequence processing algorithm 1008 may consider contextual information (e.g., spatial relationships between teeth) in addition to the features of the individual tooth masks to determine whether any corrections to the input sequence 1006 should be made (e.g., whether the ordering of the tooth masks based on the first tooth identifiers is likely correct or incorrect). In some embodiments, the sequence processing algorithm 1008 is configured to determine a second tooth identifier for each tooth mask in the input sequence 1006, based on features of the tooth masks of one or more teeth proximate to the tooth corresponding to the tooth mask. The second tooth identifier for a tooth may be different from the first tooth identifier for that tooth if the sequence processing algorithm 1008 determines that the first tooth identifier was likely incorrect, meaning that the corresponding tooth mask was in the incorrect position in the input sequence 1006. Conversely, the second tooth identifier for a tooth may be the same as the first identifier for that tooth if the sequence processing algorithm 1008 determines that the first tooth identifier was likely correct, meaning that the corresponding tooth mask was in the correct position in the input sequence 1006.

In some embodiments, the sequence processing algorithm 1008 is or includes a neural network, such as a recurrent neural network (RNN). RNNs are configured to process sequential and/or ordered data by retaining information from previous steps. For instance, an RNN may include a plurality of recurrent units having hidden states. The hidden states may retain information from previous inputs in the sequence using feedback loops. In some embodiments, the RNN is or includes a bidirectional RNN, such as a Bidirectional Long Short-Term Memory (Bi-LSTM) model. A Bi-LSTM can be an RNN that processes sequential data in both forward and backward directions. A Bi-LSTM may include a plurality of gated cells configured to selectively retain or discard information. Alternatively or in combination, the RNN can be or include an encoder-decoder model. An encoder-decoder model may include an encoder configured to compress input data into a hidden state and an encoder configured to generate the output from the hidden state.

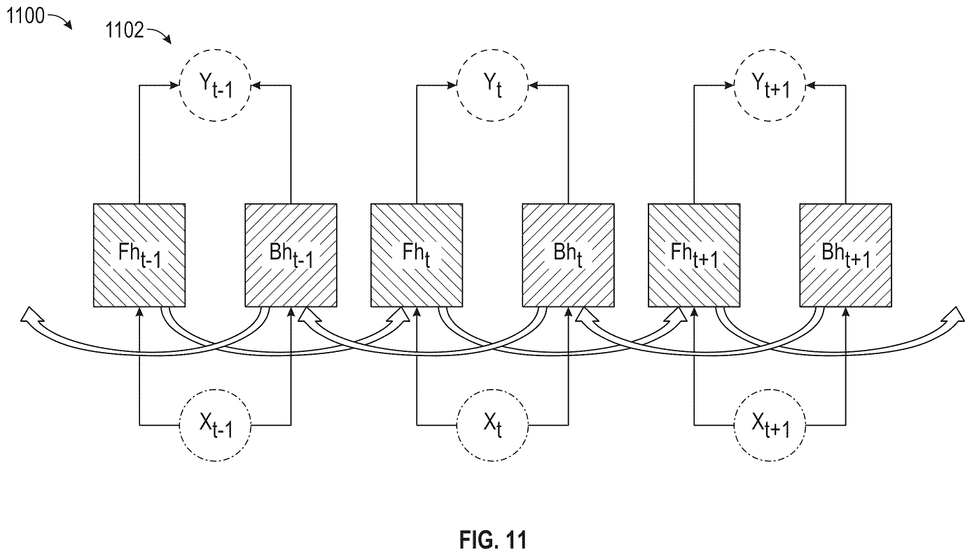

FIG. 11 illustrates a representative example of a sequence processing algorithm 1100, in accordance with embodiments of the present technology. The sequence processing algorithm 1100 can be used in a tooth identification workflow, such as the workflow 1000 of FIG. 10, to identify teeth in a patient image. The sequence processing algorithm 1100 can be implemented across any desired software and/or hardware components by any of the systems and devices described herein.

The sequence processing algorithm 1100 includes a neural network 1102. Although the neural network 1102 is depicted as being a Bi-LSTM model, other types of neural networks 1102 may be used, such other types of RNNs (e.g., an encoder-decoder model).

The neural network 1102 is configured to receive an input sequence, such as the input sequence 1006 of the workflow 1000 of FIG. 10. The input sequence can include a plurality of tooth masks (and/or features extracted from the tooth masks) that are ordered based on their respective tooth identifiers. In the illustrated embodiment, the input sequence is represented by the circles labeled using the convention “Xₙ,” where each circle represents a single tooth mask n and/or features extracted from that the tooth mask, and “Xₙ” denotes the first tooth identifier for that tooth mask (e.g., the initial guess for the tooth identifier produced by the segmentation algorithm). For instance, Xₜ is a first tooth identifier for a tooth mask “t,” Xₜ₋₁ is a first tooth identifier for a tooth mask “t−1” (the tooth mask immediately preceding tooth mask t in the input sequence), and Xₜ₊₁ is a first tooth identifier for a tooth mask “t+1” (the tooth mask immediately following tooth mask t in the input sequence).

The features in the input sequence may be feature vectors including one or more of the following, for each tooth mask: a relative location of the tooth mask, a size of the tooth mask, or a shape of the tooth mask. For instance, the feature vectors may include any of the following: the relative location of the tooth mask centroid relative to a reference location (e.g., the mouth center in the associated 2D image), the contour edge length of the tooth mask, the contour width of the tooth mask, the contour height of the tooth mask, sampled contour points in the tooth mask (e.g., cusps, grooves), the size of the tooth (e.g., as defined by r=\sqrt{a/π}, where a is the area of the tooth mask), etc. Some or all of the features may be normalized, e.g., location-based features may be normalized based on mouth length, whereas size-based features may be normalized based on average size across all tooth masks.

The output sequence produced by the neural network 1102 can be second tooth identifiers for each of the tooth masks in the input sequence. As previously discussed, the second tooth identifier may be the same as the first tooth identifier if the neural network 1102 determines that the first tooth identifier was correct, and may be different from the first tooth identifier that the first tooth identifier was incorrect. In the illustrated embodiment, the output sequence is represented by the circles labeled using the convention “Yₙ,” where each circle represents the second (e.g., updated) tooth identifier for the tooth mask that originally was assigned a first tooth identifier “Xₙ.” For instance, Yₜ is the second tooth identifier for the tooth mask “t” that originally had a first tooth identifier Xₜ, Yₜ₋₁ is the second tooth identifier for the tooth mask “t−1” that originally had a first tooth identifier Xₜ₋₁, and Yₜ₊₁ is the second tooth identifier for the tooth mask “t+1” that originally had a first tooth identifier Xₜ₊₁.

As shown in FIG. 11, the neural network 1102 can be configured to evaluate the input sequence X in both forward and backward directions to determine the output sequence Y. For instance, the neural network 1102 can include one or more first hidden layers configured to process sequential data in the forward direction to generate a plurality of forward hidden states (represented by the boxes labeled “Fh”), and one or more second hidden layers configured to process sequential data in the backward direction to generate a plurality of backward hidden states (represented by the boxes labeled “Bh”). Each of the first hidden layer(s) and the second hidden layer(s) can include a plurality of cells for computing hidden states based on the input sequence, and generating an output sequence based on the hidden states.

For instance, for forward processing of the input sequence, forward hidden state Fhₜ (corresponding to a tooth mask t) is determined based on the input Xₜ (corresponding to the tooth mask t) and the previous forward hidden state Fhₜ₋₁ (corresponding to a tooth mask t−1); forward hidden state Fhₜ₊₁ (corresponding to a tooth mask t+1) is determined based on the input Xₜ₊₁ (corresponding to the tooth mask t+1) and the previous forward hidden state Fhₜ (corresponding to the tooth mask t); etc. For backward processing of the input sequence, backward hidden state Bhₜ (corresponding to the tooth mask t) is determined based on the input Xₜ (corresponding to the tooth mask t) and the subsequent backward hidden state Bhₜ₊₁ (corresponding to the tooth mask t+1); hidden state Bhₜ₋₁ (corresponding to a tooth mask t−1) is determined based on the input Xₜ₋₁ (corresponding to the tooth mask t−1) and the subsequent backward hidden state Bhₜ (corresponding to the tooth mask t); etc. Each second tooth identifier in the output sequence can then be determined based on the forward and backward hidden states for the corresponding tooth mask. For example, a second tooth identifier Yₜ for tooth mask t can be determined based on the forward hidden state Fhₜ and backward hidden state Bhₜ; a second tooth identifier Yₜ₊₁ for tooth mask t+1 can be determined based on the forward hidden state Fhₜ₊₁ and backward hidden state Bhₜ₊₁; etc.

The neural network 1102 can be trained using training data including input sequences and corresponding second tooth identifiers. The input sequences and corresponding second tooth identifiers may be from previous 2D images of patients' teeth. In some embodiments, training the neural network 1102 includes partitioning the training data, e.g., using a train-test split, k-fold cross-validation, and/or other forms of data partitioning. For instance, the neural network 1102 can be trained using the training set, such that the neural network 1102 learns how to predict second tooth identifiers from the training set. Thereafter, the neural network 1102 can be tested on the test set. A loss (e.g., error) can be computed based on the test set, such as by evaluating the difference between the known second tooth identifiers and the predicted second tooth identifiers, and the neural network 1102 can be retrained accordingly. In some embodiments, retraining the neural network 1102 includes modifying one or more parameters and/or hyperparameters of the neural network 1102. The modifiable parameters can include the number of layers, number of “neurons” per layer, the type of cell, output dropout, state dropout, variational dropout, learning rate, decay factor, beta coefficient, maximum number of iterations, etc. Once the loss is below a predetermined error tolerance, the neural network 1102 is considered trained and can be configured to receive new input sequences and predict second tooth identifiers based on the new data.

In some embodiments, a sequence processing algorithm is trained independently from a segmentation algorithm. For instance, returning to FIG. 10, the segmentation algorithm 1004 and the sequence processing algorithm 1008 can have separate loss functions, and the segmentation algorithm 1004 and the sequence processing algorithm 1008 may be trained based on their respective loss functions. This approach can provide improved flexibility, in that each algorithm can be selected, trained, and used independently of each other. Alternatively, a sequence processing algorithm can be trained in conjunction with a segmentation algorithm. For instance, the segmentation algorithm 1004 and the sequence processing algorithm 1008 may share a loss function, and the segmentation algorithm 1004 and the sequence processing algorithm 1008 may be trained front-to-back based on the shared loss function. This approach may improve the efficiency of the training process.

The workflow 1000 can further include determining tooth assignments 1010 for the 2D image 1002. In some embodiments, the tooth assignments 1010 include a tooth mask and a second tooth identifier for each tooth that were determined by the sequence processing algorithm 1008. Optionally, the workflow 1000 can include outputting the tooth assignments 1010, e.g., on a display. For instance, the tooth assignments 1008 may be superimposed on the patient's teeth in the 2D image 1002, e.g., as shown in FIG. 2C. Alternatively or in combination, the tooth assignments 1010 can be stored as a tooth segmentation mask corresponding to the 2D image 1002. The tooth assignments 1010 and/or the 2D image 1002 can be used in dental monitoring, treatment planning, and/or the construction of dental models, e.g., as described elsewhere herein.

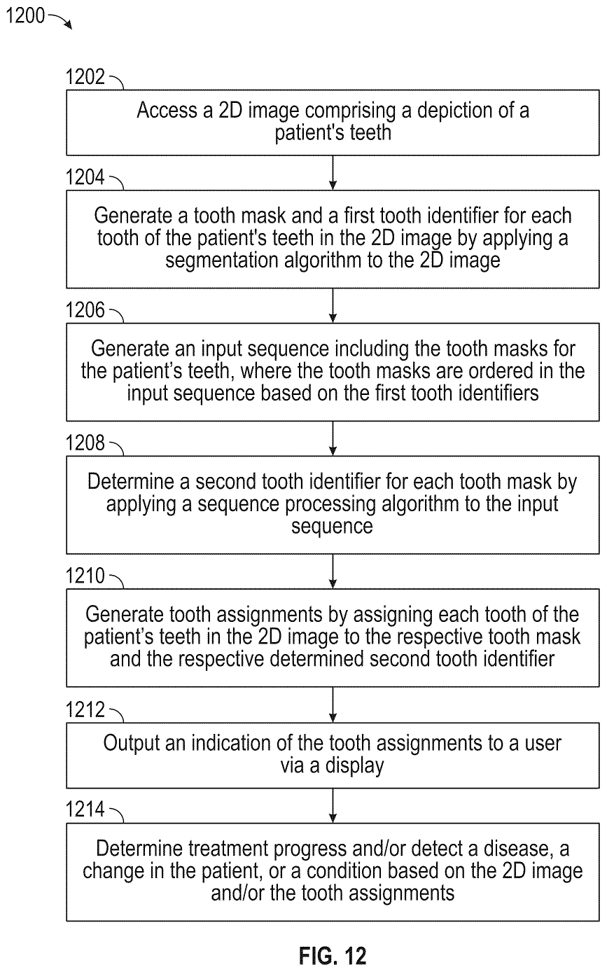

FIG. 12 is a flow diagram illustrating a method 1200 for identifying teeth in a patient image, in accordance with embodiments of the present technology. In some embodiments, some or all of the processes of the method 1200 are implemented as computer-readable instructions (e.g., program code) that are configured to be executed by one or more processors of a computing device (e.g., a mobile device, laptop, personal computer, workstation, remote server). In some embodiments, the computing device is part of a virtual dental care system as described in, e.g., U.S. Patent Application Publication No. 2022/0023003. The method 1200 can be utilized and/or combined with any of the other workflows and/or methods described herein, such as the workflow 1000 of FIG. 10.

The method 1200 can begin at block 1202 with accessing a 2D image comprising a depiction of a patient's teeth. The 2D image can be generally similar or identical to any of the 2D images described herein, such as the 2D image 102 of the workflow 100 of FIG. 1, the 2D image 200 of FIG. 2, and/or the 2D image 1002 of the workflow 1000 of FIG. 10. For instance, the 2D image can be a photograph of the patient's face, and the 2D image can be composed of a plurality of pixels.

The method 1200 can continue at block 1204 with generating a tooth mask and a first tooth identifier for each tooth of the patient's teeth in the 2D image. In some embodiments, the tooth masks and first tooth identifiers are generated by applying a segmentation algorithm to the 2D image. The segmentation algorithm can be generally similar to any of the segmentation algorithms described herein, such as the first segmentation algorithm 104 and/or the second segmentation algorithm 108 of the workflow 100 of FIG. 1. For instance, the segmentation algorithm can be an object instance segmentation algorithm, a semantic segmentation algorithm, or a combination thereof (e.g., a panoptic segmentation algorithm). In some embodiments, the first tooth identifiers produced by the segmentation algorithm may be an initial or “first-pass” tooth identification for the patient's teeth.

The method 1200 can continue at block 1206 with generating an input sequence including the tooth masks for the patient's teeth. The input sequence can be the same or generally similar to the input sequence 1006 of the workflow 1000 of FIG. 10. For instance, the input sequence may include an ordered arrangement of the tooth masks and/or features extracted from the tooth masks based on the first tooth identifiers (e.g., in ascending or descending order of the first tooth identifiers).

The method 1200 can continue at block 1208 with determining a second tooth identifier for each tooth mask. In some embodiments, the second tooth identifiers are determined by applying a sequence processing algorithm to the input sequence. The sequence processing algorithm can be the same or generally similar to the sequence processing algorithm 1008 of the workflow 1000 of FIG. 10. For instance, the sequence processing algorithm can be an RNN, such as a Bi-LSTM model (e.g., as described with respect to FIG. 11) or an encoder-decoder model. In some embodiments, the sequence processing algorithm determines the second tooth identifiers based on contextual information, such as based on features of the tooth masks of one or more teeth proximate to the tooth of interest. The second tooth identifier for a tooth may be different from the first tooth identifier for that tooth if the sequence processing algorithm determines that the first tooth identifier was likely incorrect, or may be the same as the first identifier for that tooth if the sequence processing algorithm determines that the first tooth identifier was likely correct.

The method 1200 can continue at block 1210 with generating tooth assignments by assigning each tooth of the patient's teeth in the 2D image to the respective tooth mask and the respective second tooth identifier.

The method 1200 can continue at block 1212 with outputting an indication of the tooth assignments to a user via a display. The processes of block 1212 can be the same or generally similar to the processes of block 612 of the method 600 of FIG. 6. For instance, the tooth assignments can be displayed on a monitor or screen that is associated with a computing device (e.g., a mobile device, personal computer, laptop, tablet, workstation). The computing device can be part of a computing system (e.g., a virtual dental care system) that includes one or more local client devices (e.g., patient devices and/or clinician devices) communicably coupled to a remote server (e.g., of a dental appliance manufacturer and/or a treatment monitoring service provider) via a communications network. The tooth assignments can be displayed as a graphical overlay over the 2D image. For instance, the tooth assignments can include tooth masks and tooth identifiers directly overlaid on the patient's teeth in the 2D image.

The method 1200 can continue at block 1214 with determining treatment progress and/or detecting a disease, a change in the patient, or a condition based on the 2D image and/or the tooth assignments, for example, as discussed previously with respect to method 900. The processes of block 1214 can be the same as or generally similar to the processes of block 614 of the method 600 of FIG. 6. For instance, the 2D image and the tooth assignments may be sent to the patient's clinician, and the clinician may assess the patient's treatment progress and/or dental condition based on the 2D image and the tooth assignments. Alternatively or in addition, the treatment evaluation and/or monitoring may be completed automatically.

The method 1200 illustrated in FIG. 12 can be modified in many different ways. For example, although the above processes of the method 1200 are described with respect to a single 2D image, the method 1200 can be used to sequentially or concurrently identify teeth in any suitable number of images. As another example, the ordering of the processes shown in FIG. 12 can be varied, or some processes may be performed concurrently, e.g., the processes of blocks 1204 and 1206 may occur at the same. In some embodiments, the method 1200 may be performed on a remote server. For example, a patient or doctor device (e.g., a smartphone) may be used to capture a 2D image, and this 2D image may be transmitted to the remote server (e.g., via a smartphone application). The remote server may then execute any of the processes of blocks 1202-1210. In other embodiments, the method 1200 may be entirely performed on a local client device (e.g., a mobile device, a personal computer). In some embodiments, some of the steps may be performed on a remote server, and some of the steps may be performed on a local client device. Some of the processes of the method 1200 can be omitted (e.g., the process of block 1208 and/or the process of block 1210) and/or the method 1200 can include processes not shown in FIG. 12 (e.g., administering a treatment plan to address a detected disease, change in the patient, or condition; generating a modified dental treatment plan based on the patient's treatment progress and administering the modified dental treatment plan to the patient).

Any of the segmentation algorithms described herein (e.g., the first segmentation algorithm 104 and/or the second segmentation algorithm 108 of the workflow 100 of FIG. 1, the segmentation algorithm 704 of the workflow 700 of FIG. 7, the segmentation algorithm 800 of FIG. 8, the segmentation algorithm 1004 of the workflow 1000 of FIG. 10), can take topological features into consideration when generating tooth masks from a 2D image of a patient's teeth. The topological features may be indicative of the connectedness and continuity of the tooth masks, e.g., whether the tooth mask is a single contiguous shape or multiple discrete shapes; whether the tooth mask includes discontinuities such as loops, holes, voids, etc. In some embodiments, tooth masks with a high degree of topological error (e.g., tooth masks that are composed of a plurality of discrete shapes and/or that include discontinuities) are not anatomically plausible and are thus likely to be incorrect, whereas tooth masks with a low degree of topological error (e.g., tooth masks that are composed of a single contiguous shape and/or have few or no discontinuities) are more likely to be correct.

Accordingly, the segmentation algorithms herein can be configured to generate tooth masks having reduced or no topological errors. This can be accomplished, for example, by generating an initial proposal for tooth masks, determining the topological error associated with each tooth masks, and then adjusting some or all of the tooth masks to reduce the topological error. The adjustment can be made by incorporating a topological loss function into the segmentation algorithm, where the topological loss function penalizes tooth masks having a large amount of topological error. The topological loss function may be used in combination with or as an alternative to other types of loss functions used in segmentation, such as cross-entropy loss functions and/or dice loss functions. For example, the topological loss calculated using the topological loss function can be combined with (e.g., added to) the loss calculated using other types of loss functions, and the total loss can be used to optimize the tooth masks determined by the segmentation algorithm.

In some embodiments, the input into the topological loss function has a reduced image size to decrease the computational resources and training time associated with evaluating topological error. Reduction of the image size may be achieved in various ways. For instance, the 2D image can be cropped to a smaller size so that the topological error is evaluated for a smaller portion of the 2D image only, rather than the entire image. The smaller portion may be, for example, the portion of the image depicting the teeth and/or immediately adjacent to the teeth. In some embodiments, the smaller portion includes a single tooth (or a smaller group of teeth), such that the topological error is evaluated on a per-tooth basis (or per smaller group of teeth). Alternatively or in combination, the reduction of the image size can be achieved by downsampling the 2D image (e.g., reducing the image resolution) so that the total number of pixels is decreased compared to the original image. The downsampling can be achieved in a manner that allows the output of the topological loss function to be backpropagated.

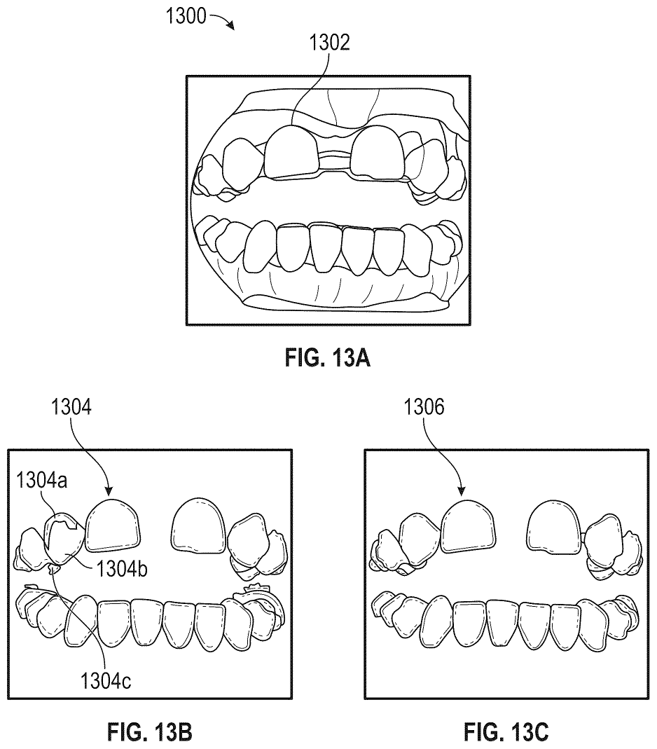

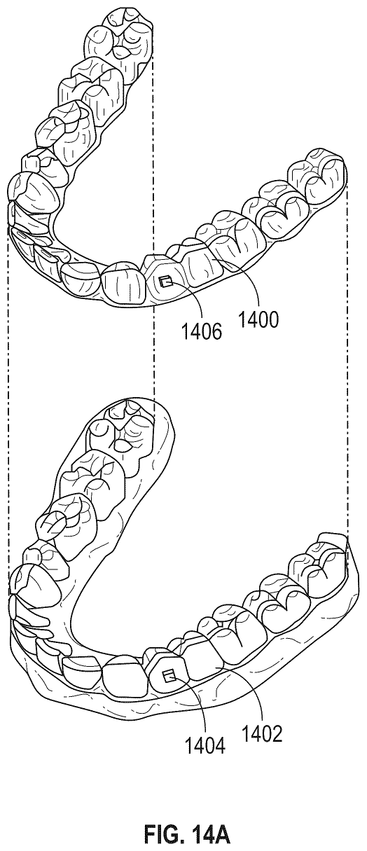

FIGS. 13A-13C illustrate a representative example of a tooth identification process with and without a topological loss function, in accordance with embodiments of the present technology. These figures are based on photos from a patient with a missing tooth #7. Specifically, FIG. 13A illustrates a representative example of a 2D image 1300 including a depiction of a patient's teeth 1302, FIG. 13B illustrates a first plurality of tooth masks 1304 determined from the 2D image 1300 without a topological loss function, and FIG. 13C illustrates a second plurality of tooth masks 1306 determined from the 2D image 1300 with a topological loss function.

Referring first to FIG. 13A, the 2D image 1300 can be generally similar or identical to any of the 2D images described herein, such as the 2D image 102 of the workflow 100 of FIG. 1 or the 2D image 200 of FIG. 2A. For instance, the 2D image 1300 can be a photograph of the patient's face (e.g., an intraoral or extraoral photograph), and the 2D image 1300 can be composed of a plurality of pixels.

Referring next to FIG. 13B, in the illustrated example, the first plurality of tooth masks 1304 are determined from the 2D image 1300 using a segmentation algorithm that does not incorporate a topological loss function. As shown, the first plurality of tooth masks 1304 generated by the segmentation algorithm may exhibit significant topological errors. For instance, because the patient in this example, is missing tooth #7, the segmentation algorithm was confused and incorrectly mapped two tooth masks (a first tooth mask 1304a and a second tooth mask 1304b for teeth #6 and #7) over a region corresponding to a single tooth (tooth #7). Thus, the first tooth mask 1304a is significantly smaller than the expected size for a tooth and has an atypically elongated aspect ratio. Moreover, the first and second tooth masks 1304a, 1304b each have a jagged, irregular border that is not anatomically plausible. Further, the first plurality of tooth masks 1304 includes extraneous tooth masks 1304c that do not appear to map onto any of the patient's teeth.

Referring next to FIG. 13C, in the illustrated example, the second plurality of tooth masks 1306 are determined from the 2D image 1300 using a segmentation algorithm that includes a topological loss function. As shown, the second plurality of tooth masks 1306 correctly mapped a single tooth mask for tooth #6 and did not map on a separate mask for missing tooth #7. Thus, the topological loss model is able to reduce errors—especially in cases where there are missing teeth, supernumerary teeth, non-standard tooth shapes (e.g., from chipped or broken teeth), or other atypical configurations and results in a more anatomically plausible result that accurately captures the actual shapes and boundaries of the teeth in the 2D image 1300.

### II. Dental Appliances and Associated Methods

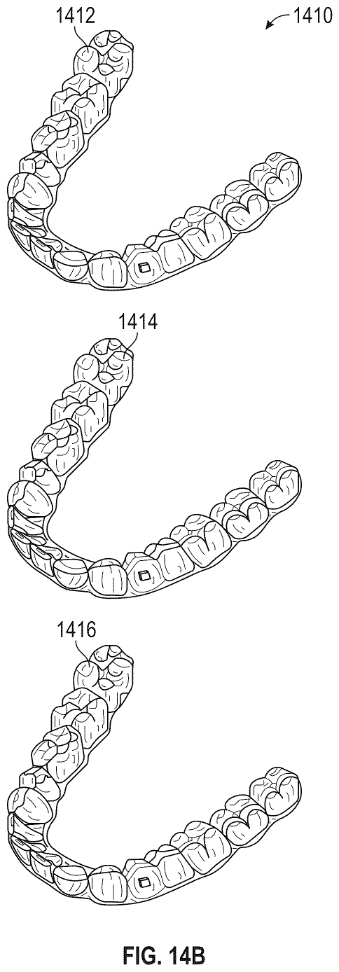

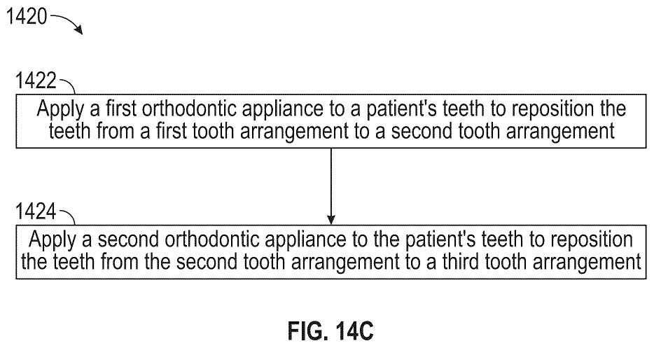

FIG. 14A illustrates a representative example of a tooth repositioning appliance 1400 configured in accordance with embodiments of the present technology. The appliance 1400 can be used in combination with any of the systems, methods, and devices described herein. The appliance 1400 (also referred to herein as an “aligner”) can be worn by a patient in order to achieve an incremental repositioning of individual teeth 1402 in the jaw. The appliance 1400 can include a shell (e.g., a continuous polymeric shell or a segmented shell) having teeth-receiving cavities that receive and resiliently reposition the teeth. The appliance 1400 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1400 can fit over all teeth present in an upper or lower jaw, or less than all of the teeth. The appliance 1400 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1400 can be a generic appliance configured to receive the teeth, but not necessarily shaped to match the topography of the patient's teeth. In some cases, only certain teeth received by the appliance 1400 are repositioned by the appliance 1400 while other teeth can provide a base or anchor region for holding the appliance 1400 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1400 in place over the teeth. In some cases, however, it may be desirable or necessary to provide individual attachments 1404 or other anchoring elements on teeth 1402 with corresponding receptacles 1406 or apertures in the appliance 1400 so that the appliance 1400 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 14B illustrates a tooth repositioning system 1410 including a plurality of appliances 1412, 1414, 1416, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1410 can include a first appliance 1412 corresponding to an initial tooth arrangement, one or more intermediate appliances 1414 corresponding to one or more intermediate arrangements, and a final appliance 1416 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 14C illustrates a method 1420 of orthodontic treatment using a plurality of appliances, in accordance with embodiments of the present technology. The method 1420 can be practiced using any of the appliances or appliance sets described herein. In block 1422, a first orthodontic appliance is applied to a patient's teeth in order to reposition the teeth from a first tooth arrangement to a second tooth arrangement. In block 1424, a second orthodontic appliance is applied to the patient's teeth in order to reposition the teeth from the second tooth arrangement to a third tooth arrangement. The method 1420 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

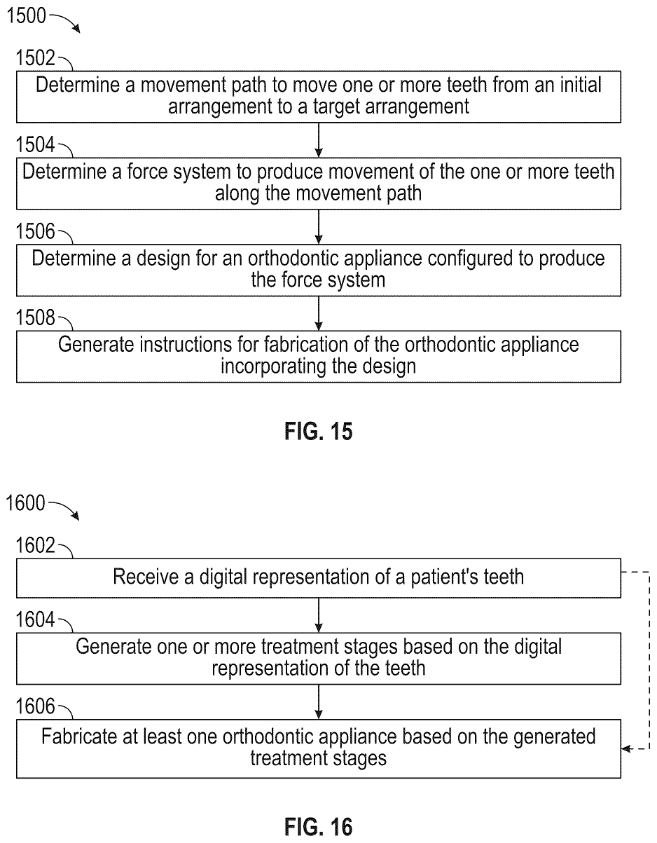

FIG. 15 illustrates a method 1500 for designing an orthodontic appliance, in accordance with embodiments of the present technology. The method 1500 can be applied to any embodiment of the orthodontic appliances described herein. Some or all of the steps of the method 1500 can be performed by any suitable data processing system or device, e.g., one or more processors configured with suitable instructions.

In block 1502, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1504, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1504 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1506, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1508, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1500 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1500 may be performed with any suitable fabrication system or device, such as the embodiments described herein. Some of the steps may be optional, e.g., the process of block 1504 can be omitted, such that the orthodontic appliance is designed based on the desired tooth movements and/or determined tooth movement path, rather than based on a force system. Moreover, the order of the steps can be varied as desired.

FIG. 16 illustrates a method 1600 for digitally planning an orthodontic treatment and/or design or fabrication of an appliance, in accordance with embodiments. The method 1600 can be applied to any of the treatment procedures described herein and can be performed by any suitable data processing system.

In block 1602, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1604, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1606, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 16, design and/or fabrication of an orthodontic appliance, and perhaps a particular orthodontic treatment, may include use of a representation of the patient's teeth (e.g., including receiving a digital representation of the patient's teeth (block 1602)), followed by design and/or fabrication of an orthodontic appliance based on a representation of the patient's teeth in the arrangement represented by the received representation.

As noted herein, the techniques described herein can be used in combination with directly fabricated dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used in combination with attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled, “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used in combination with incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A system for identifying teeth in a patient image, the system comprising:
one or more processors; and
a memory operably coupled to the one or more processors and storing instructions that, when executed by the one or more processors, cause the system to perform operations comprising:
   accessing a two-dimensional (2D) image comprising a depiction of a patient's teeth, wherein the 2D image is composed of a plurality of pixels;
   generating a set of tooth identifier probabilities by applying a first segmentation algorithm to the 2D image, wherein each tooth identifier probability represents a likelihood that a pixel of the 2D image corresponds to a particular tooth identifier of a plurality of tooth identifiers for the teeth;
   generating a set of tooth mask probabilities by applying a second segmentation algorithm to the 2D image, wherein each tooth mask probability represents a likelihood that a pixel of the 2D image is associated with a particular tooth mask of a plurality of tooth masks for the teeth;
   generating a set of mask identifier probabilities by combining the set of tooth identifier probabilities and the set of tooth mask probabilities, wherein each mask identifier probability represents a likelihood that a particular tooth mask of the plurality of tooth masks corresponds to a particular tooth identifier of the plurality of tooth identifiers; and
   generating tooth assignments by assigning each tooth of the patient's teeth in the 2D image to a respective tooth mask of the plurality of tooth masks and a respective tooth identifier of the plurality of tooth identifiers, based on the set of mask identifier probabilities.

Example 2. The system of Example 1, wherein the first segmentation algorithm comprises a semantic segmentation algorithm, and wherein the second segmentation algorithm comprises an object instance segmentation algorithm.

Example 3. The system of Example 1 or 2, wherein the first segmentation algorithm is configured to assign a category to each pixel of the 2D image, wherein the category corresponds to one of the plurality of tooth identifiers.

Example 4. The system of any one of Examples 1 to 3, wherein the second segmentation algorithm is configured to identify a boundary for each tooth of the 2D image, wherein the boundary corresponds to one of the plurality of tooth masks.

Example 5. The system of any one of Examples 1 to 4, wherein the operations further comprise outputting an indication of the tooth assignments to a user via a display.

Example 6. The system of Example 5, wherein the indication comprises a tooth segmentation mask, the tooth segmentation mask comprising the plurality of tooth masks and the corresponding tooth identifiers.

Example 7. The system of Example 5 or 6, wherein the indication comprises an overlay superimposed on the patient's teeth in the 2D image, the overlay comprising the plurality of tooth masks and the corresponding tooth identifiers.

Example 8. The system of any one of Examples 5 to 7, wherein the display is remote from the one or more processors.

Example 9. The system of any one of Examples 1 to 8, wherein the operations further comprise:
detecting a disease, a change in the patient, or a condition of the patient's teeth based on the 2D image and the tooth assignments, and
outputting an indication of the disease, the change in the patient, or the condition of the patient's teeth to a user via a display.

Example 10. The system of any one of Examples 1 to 9, wherein the operations further comprise:
determining progress of the patient's teeth with respect to a dental treatment plan based on the 2D image and the tooth assignments, and
outputting an indication of the progress to a user via a display.

Example 11. The system of any one of Examples 1 to 10, wherein generating the set of mask identifier probabilities comprises, for each tooth mask of the plurality of tooth masks:
for each tooth identifier of the plurality of tooth identifiers, combining the set of tooth identifier probabilities and the set of tooth mask probabilities to determine a pixelwise likelihood that each pixel in the 2D image is associated with the tooth mask and the tooth identifier, and
combining the pixelwise likelihoods to determine an overall likelihood that the tooth mask corresponds to the tooth identifier.

Example 12. The system of any one of Examples 1 to 11, wherein the operations further comprise adjusting at least some of the set of mask identifier probabilities based on patient data.

Example 13. The system of Example 12, wherein the patient data comprises information regarding missing teeth or supernumerary teeth of the patient.

Example 14. The system of Example 12 or 13, wherein the adjusting comprises removing at least one of the mask identifier probabilities to account for at least one missing tooth of the patient's teeth.

Example 15. The system of any one of Examples 1 to 14, wherein the operations further comprise reordering the set of mask identifier probabilities based on an expected value for each tooth mask.

Example 16. The system of any one of Examples 1 to 15, wherein the assigning is performed using a maximum-likelihood algorithm.

Example 17. The system of any one of Examples 1 to 16, wherein the operations further comprise:
downsampling the 2D image from an initial resolution to a downsampled resolution before applying the first segmentation algorithm to the 2D image, and
upsampling the set of tooth identifier probabilities from the downsampled resolution to the initial resolution.

Example 18. The system of any one of Examples 1 to 17, wherein the operations further comprise:
downsampling the 2D image from an initial resolution to a downsampled resolution before applying the second segmentation algorithm to the 2D image, and
upsampling the set of tooth mask probabilities from the downsampled resolution to the initial resolution.

Example 19. The system of any one of Examples 1 to 18, wherein the 2D image comprises a photograph, a frame of a video, or a radiograph.

Example 20. The system of any one of Examples 1 to 19, wherein the 2D image is obtained from an imaging device that is remote from the one or more processors.

Example 21. The system of Example 20, wherein the imaging device comprises a camera that is part of or is operably coupled to a mobile device.

Example 21A. The system of any one of Examples 1 to 21, wherein at least one of the first segmentation algorithm or the second segmentation algorithm includes a topological loss function.

Example 22. The system of any one of Examples 1 to 21A, wherein the one or more processors are part of a local client device.

Example 23. The system of any one of Examples 1 to 21A, wherein the one or more processors are part of a server computing device.

Example 24. A computer-implemented method for identifying teeth in a patient image, the computer-implemented method comprising, by one or more processors:
accessing a two-dimensional (2D) image comprising a depiction of a patient's teeth, wherein the 2D image is composed of a plurality of pixels;
transmitting, to a server computing device, the 2D image; and
receiving, from the server computing device, a tooth assignment for each tooth of the patient's teeth in the 2D image, wherein the tooth assignments are generated by:
   generating a set of tooth identifier probabilities by applying a first segmentation algorithm to the 2D image, wherein each tooth identifier probability represents a likelihood that a pixel of the 2D image corresponds to a particular tooth identifier of a plurality of tooth identifiers for the teeth,
   generating a set of tooth mask probabilities by applying a second segmentation algorithm to the 2D image, wherein each tooth mask probability represents a likelihood that a pixel of the 2D image is associated with a particular tooth mask of a plurality of tooth masks for the teeth,
   generating a set of mask identifier probabilities by combining the set of tooth identifier probabilities and the set of tooth mask probabilities, wherein each mask identifier probability represents a likelihood that a particular tooth mask of the plurality of tooth masks corresponds to a particular tooth identifier of the plurality of tooth identifiers, and
   assigning each tooth of the patient's teeth in the 2D image to a respective tooth mask of the plurality of tooth masks and a respective tooth identifier of the plurality of tooth identifiers, based on the set of mask identifier probabilities.

Example 25. The computer-implemented method of Example 24, wherein the first segmentation algorithm comprises a semantic segmentation algorithm, and wherein the second segmentation algorithm comprises an object instance segmentation algorithm.

Example 26. The computer-implemented method of Example 24 or 25, wherein the first segmentation algorithm is configured to assign a category to each pixel of the 2D image, wherein the category corresponds to one of the plurality of tooth identifiers.

Example 27. The computer-implemented method of any one of Examples 24 to 26, wherein the second segmentation algorithm is configured to identify a boundary for each tooth of the 2D image, wherein the boundary corresponds to one of the plurality of tooth masks.

Example 28. The computer-implemented method of any one of Examples 24 to 27, further comprising outputting an indication of the tooth assignments to a user via a display.

Example 29. The computer-implemented method of Example 28, wherein the indication comprises a tooth segmentation mask, the tooth segmentation mask comprising the plurality of tooth masks and the corresponding tooth identifiers.

Example 30. The computer-implemented method of Example 28 or 29, wherein the indication comprises an overlay superimposed on the patient's teeth in the 2D image, the overlay comprising the plurality of tooth masks and the corresponding tooth identifiers.

Example 31. The computer-implemented method of any one of Examples 24 to 30, further comprising:
detecting a disease, a change in the patient, or a condition of the patient's teeth based on the 2D image and the tooth assignments, and
outputting an indication of the disease, the change in the patient, or the condition of the patient's teeth to a user via a display.

Example 32. The computer-implemented method of any one of Examples 24 to 31, further comprising:
determining progress of the patient's teeth with respect to a dental treatment plan based on the 2D image and the tooth assignments, and
outputting an indication of the progress to a user via a display.

Example 33. The computer-implemented method of any one of Examples 24 to 32, wherein generating the set of mask identifier probabilities comprises, for each tooth mask of the plurality of tooth masks:
for each tooth identifier of the plurality of tooth identifiers, combining the set of tooth identifier probabilities and the set of tooth mask probabilities to determine a pixelwise likelihood that each pixel in the 2D image is associated with the tooth mask and the tooth identifier, and
combining the pixelwise likelihoods to determine an overall likelihood that the tooth mask corresponds to the tooth identifier.

Example 34. The computer-implemented method of any one of Examples 24 to 33, wherein the generation of the tooth assignments further comprises adjusting at least some of the set of mask identifier probabilities based on patient data.

Example 35. The computer-implemented method of Example 34, wherein the patient data comprises information regarding missing teeth or supernumerary teeth of the patient.

Example 36. The computer-implemented method of Example 34 or 35, wherein the adjusting comprises removing at least one of the mask identifier probabilities to account for at least one missing tooth of the patient's teeth.

Example 37. The computer-implemented method of any one of Examples 24 to 36, wherein the generation of the tooth assignments further comprises reordering the set of mask identifier probabilities based on an expected value for each tooth mask.

Example 38. The computer-implemented method of any one of Examples 24 to 37, wherein the assigning is performed using a maximum-likelihood algorithm.

Example 39. The computer-implemented method of any one of Examples 24 to 38, wherein the generation of the tooth assignments further comprises:
downsampling the 2D image from an initial resolution to a downsampled resolution before applying the first segmentation algorithm to the 2D image, and
upsampling the set of tooth identifier probabilities from the downsampled resolution to the initial resolution.

Example 40. The computer-implemented method of any one of Examples 24 to 39, wherein the generation of the tooth assignments further comprises:
downsampling the 2D image from an initial resolution to a downsampled resolution before applying the second segmentation algorithm to the 2D image, and
upsampling the set of tooth mask probabilities from the downsampled resolution to the initial resolution.

Example 41. The computer-implemented method of any one of Examples 24 to 40, wherein the 2D image comprises a photograph, a frame of a video, or a radiograph.

Example 41A. The computer-implemented method of any one of Examples 24 to 41, wherein at least one of the first segmentation algorithm or the second segmentation algorithm includes a topological loss function.

Example 42. The computer-implemented method of any one of Examples 24 to 41A, wherein the 2D image is obtained from an imaging device.

Example 43. The computer-implemented method of Example 42, wherein the imaging device comprises a camera that is part of or is operably coupled to a mobile device.

Example 44. A computer-implemented method for identifying teeth in a patient image, the computer-implemented method comprising, by one or more processors:
accessing a two-dimensional (2D) image comprising a depiction of a patient's teeth, wherein the 2D image is composed of a plurality of pixels;
generating a set of tooth identifier probabilities by applying a first segmentation algorithm to the 2D image, wherein each tooth identifier probability represents a likelihood that a pixel of the 2D image corresponds to a particular tooth identifier of a plurality of tooth identifiers for the teeth;
generating a set of tooth mask probabilities by applying a second segmentation algorithm to the 2D image, wherein each tooth mask probability represents a likelihood that a pixel of the 2D image is associated with a particular tooth mask of a plurality of tooth masks for the teeth;
generating a set of mask identifier probabilities by combining the set of tooth identifier probabilities and the set of tooth mask probabilities, wherein each mask identifier probability represents a likelihood that a particular tooth mask of the plurality of tooth masks corresponds to a particular tooth identifier of the plurality of tooth identifiers; and
generating tooth assignments by assigning each tooth of the patient's teeth in the 2D image to a respective tooth mask of the plurality of tooth masks and a respective tooth identifier of the plurality of tooth identifiers, based on the set of mask identifier probabilities.

Example 45. The computer-implemented method of Example 44, wherein the first segmentation algorithm comprises a semantic segmentation algorithm, and wherein the second segmentation algorithm comprises an object instance segmentation algorithm.

Example 46. The computer-implemented method of Example 44 or 45, wherein the first segmentation algorithm is configured to assign a category to each pixel of the 2D image, wherein the category corresponds to one of the plurality of tooth identifiers.

Example 47. The computer-implemented method of any one of Examples 44 to 46, wherein the second segmentation algorithm is configured to identify a boundary for each tooth of the 2D image, wherein the boundary corresponds to one of the plurality of tooth masks.

Example 48. The computer-implemented method of any one of Examples 44 to 47, further comprising outputting an indication of the tooth assignments to a user via a display.

Example 49. The computer-implemented method of Example 48, wherein the indication comprises a tooth segmentation mask, the tooth segmentation mask comprising the plurality of tooth masks and the corresponding tooth identifiers.

Example 50. The computer-implemented method of Example 48 or 49, wherein the indication comprises an overlay superimposed on the patient's teeth in the 2D image, the overlay comprising the plurality of tooth masks and the corresponding tooth identifiers.

Example 51. The computer-implemented method of any one of Examples 44 to 50, further comprising:
detecting a disease, a change in the patient, or a condition of the patient's teeth based on the 2D image and the tooth assignments, and
outputting an indication of the disease, the change in the patient, or the condition of the patient's teeth to a user via a display.

Example 52. The computer-implemented method of any one of Examples 44 to 51, further comprising:
determining progress of the patient's teeth with respect to a dental treatment plan based on the 2D image and the tooth assignments, and
outputting an indication of the progress to a user via a display.

Example 53. The computer-implemented method of any one of Examples 44 to 52, wherein generating the set of mask identifier probabilities comprises, for each tooth mask of the plurality of tooth masks:
for each tooth identifier of the plurality of tooth identifiers, combining the set of tooth identifier probabilities and the set of tooth mask probabilities to determine a pixelwise likelihood that each pixel in the 2D image is associated with the tooth mask and the tooth identifier, and
combining the pixelwise likelihoods to determine an overall likelihood that the tooth mask corresponds to the tooth identifier.

Example 54. The computer-implemented method of any one of Examples 44 to 53, further comprising adjusting at least some of the set of mask identifier probabilities based on patient data.

Example 55. The computer-implemented method of Example 54, wherein the patient data comprises information regarding missing teeth or supernumerary teeth of the patient.

Example 56. The computer-implemented method of Example 54 or 55, wherein the adjusting comprises removing at least one of the mask identifier probabilities to account for at least one missing tooth of the patient's teeth.

Example 57. The computer-implemented method of any one of Examples 44 to 56, further comprising reordering the set of mask identifier probabilities based on an expected value for each tooth mask.

Example 58. The computer-implemented method of any one of Examples 44 to 57, wherein the assigning is performed using a maximum-likelihood algorithm.

Example 59. The computer-implemented method of any one of Examples 44 to 58, further comprising:
downsampling the 2D image from an initial resolution to a downsampled resolution before applying the first segmentation algorithm to the 2D image, and
upsampling the set of tooth identifier probabilities from the downsampled resolution to the initial resolution.

Example 60. The computer-implemented method of any one of Examples 44 to 59, further comprising:
downsampling the 2D image from an initial resolution to a downsampled resolution before applying the second segmentation algorithm to the 2D image, and
upsampling the set of tooth mask probabilities from the downsampled resolution to the initial resolution.

Example 61. The computer-implemented method of any one of Examples 44 to 60, wherein the 2D image comprises a photograph, a frame of a video, or a radiograph.

Example 61A. The computer-implemented method of any one of Examples 44 to 61, wherein at least one of the first segmentation algorithm or the second segmentation algorithm includes a topological loss function.

Example 62. The computer-implemented method of any one of Examples 44 to 61A, wherein the 2D image is obtained from an imaging device.

Example 63. The computer-implemented method of Example 62, wherein the imaging device comprises a camera that is part of or is operably coupled to a mobile device.

Example 64. A non-transitory computer-readable storage medium comprising instructions that, when executed by one or more processors of a computing system, cause the computing system to perform operations comprising:
accessing a two-dimensional (2D) image comprising a depiction of a patient's teeth, wherein the 2D image is composed of a plurality of pixels;
generating a set of tooth identifier probabilities by applying a first segmentation algorithm to the 2D image, wherein each tooth identifier probability represents a likelihood that a pixel of the 2D image corresponds to a particular tooth identifier of a plurality of tooth identifiers for the teeth;
generating a set of tooth mask probabilities by applying a second segmentation algorithm to the 2D image, wherein each tooth mask probability represents a likelihood that a pixel of the 2D image is associated with a particular tooth mask of a plurality of tooth masks for the teeth;
generating a set of mask identifier probabilities by combining the set of tooth identifier probabilities and the set of tooth mask probabilities, wherein each mask identifier probability represents a likelihood that a particular tooth mask of the plurality of tooth masks corresponds to a particular tooth identifier of the plurality of tooth identifiers; and
assigning each tooth of the patient's teeth in the 2D image to a respective tooth mask of the plurality of tooth masks and a respective tooth identifier of the plurality of tooth identifiers, based on the set of mask identifier probabilities.

Example 65. The non-transitory computer-readable storage medium of Example 64, wherein the first segmentation algorithm comprises a semantic segmentation algorithm, and wherein the second segmentation algorithm comprises an object instance segmentation algorithm.

Example 66. The non-transitory computer-readable storage medium of Example 64 or 65, wherein the first segmentation algorithm is configured to assign a category to each pixel of the 2D image, wherein the category corresponds to one of the plurality of tooth identifiers.

Example 67. The non-transitory computer-readable storage medium of any one of Examples 64 to 66, wherein the second segmentation algorithm is configured to identify a boundary for each tooth of the 2D image, wherein the boundary corresponds to one of the plurality of tooth masks.

Example 68. The non-transitory computer-readable storage medium of any one of Examples 64 to 67, wherein the operations further comprise outputting an indication of the tooth assignments to a user via a display.

Example 69. The non-transitory computer-readable storage medium of Example 68, wherein the indication comprises a tooth segmentation mask, the tooth segmentation mask comprising the plurality of tooth masks and the corresponding tooth identifiers.

Example 70. The non-transitory computer-readable storage medium of Example 68 or 69, wherein the indication comprises an overlay superimposed on the patient's teeth in the 2D image, the overlay comprising the plurality of tooth masks and the corresponding tooth identifiers.

Example 71. The non-transitory computer-readable storage medium of any one of Examples 64 to 70, wherein the operations further comprise:
detecting a disease, a change in the patient, or a condition of the patient's teeth based on the 2D image and the tooth assignments, and
outputting an indication of the disease, the change in the patient, or the condition of the patient's teeth to a user via a display.

Example 72. The non-transitory computer-readable storage medium of any one of Examples 64 to 71, wherein the operations further comprise:
determining progress of the patient's teeth with respect to a dental treatment plan based on the 2D image and the tooth assignments, and
outputting an indication of the progress to a user via a display.

Example 73. The non-transitory computer-readable storage medium of any one of Examples 64 to 72, wherein the 2D image comprises a photograph, a frame of a video, or a radiograph.

Example 73A. The non-transitory computer-readable storage medium of any one of Examples 64 to 73, wherein at least one of the first segmentation algorithm or the second segmentation algorithm includes a topological loss function.

Example 74. The non-transitory computer-readable storage medium of any one of Examples 64 to 73A, wherein the 2D image is obtained from an imaging device.

Example 75. The non-transitory computer-readable storage medium of Example 74, wherein the imaging device comprises a camera that is part of or is operably coupled to a mobile device.

Example 76. A computer-implemented method for identifying teeth in a patient image, the computer-implemented method comprising, by one or more processors:
accessing a two-dimensional (2D) image comprising a depiction of a patient's teeth, wherein the 2D image is composed of a plurality of image units;
generating a set of first probabilities by applying a first segmentation algorithm to the 2D image, wherein each first probability represents a likelihood that an image unit of the 2D image corresponds to a particular tooth identifier of a plurality of tooth identifiers for the teeth;
generating a set of second probabilities by applying a second segmentation algorithm to the 2D image, wherein each second probability represents a likelihood that an image unit of the 2D image corresponds to a particular tooth mask of a plurality of tooth masks for the teeth;
generating a set of third probabilities by combining the set of first probabilities and the set of second probabilities, wherein each third probability represents a likelihood that a particular tooth mask of the plurality of tooth masks corresponds to a particular tooth identifier of the plurality of tooth identifiers; and
assigning each tooth of the patient's teeth in the 2D image to a respective tooth mask of the plurality of tooth masks and a respective tooth identifier of the plurality of tooth identifiers, based on the set of third probabilities.

Example 77. A system for identifying teeth in a patient image, the system comprising:
one or more processors; and
a memory operably coupled to the one or more processors and storing instructions that, when executed by the one or more processors, cause the system to perform operations comprising:
   accessing a two-dimensional (2D) image comprising a depiction of a patient's teeth;
   applying a segmentation algorithm to the 2D image, wherein the segmentation algorithm is configured to:
      identify a plurality of regions in the 2D image, each region corresponding to an estimated location of a tooth of the patient's teeth in the 2D image, and
      determine a tooth mask and a tooth identifier for each tooth of the patient's teeth in the 2D image, wherein the determination for each tooth is based on features of the region corresponding to the estimated location of the tooth and features of the regions corresponding to estimated locations of one or more teeth proximate to the tooth; and
   generating tooth assignments by assigning each tooth of the patient's teeth in the 2D image to the respective determined tooth mask and the respective determined tooth identifier.

Example 78. The system of Example 77, wherein the segmentation algorithm comprises an attention mechanism that determines the tooth mask and the tooth identifier for each tooth based on the features of the region corresponding to the estimated location of the tooth and the features of the regions corresponding to estimated locations of the one or more teeth proximate to the tooth.

Example 79. The system of Example 78, wherein the attention mechanism comprises a multi-head self-attention mechanism.

Example 80. The system of any one of Examples 77 to 79, wherein the segmentation algorithm is further configured to adjust at least some of the tooth masks to reduce topological errors in the tooth masks.

Example 81. The system of Example 80, wherein the segmentation algorithm is configured to perform the adjustment based on a topological loss function.

Example 82. The system of any one of Examples 77 to 81, wherein the segmentation algorithm comprises an object instance segmentation algorithm, a semantic segmentation algorithm, or a combination thereof.

Example 83. The system of any one of Examples 77 to 82, wherein the operations further comprise outputting an indication of the tooth assignments to a user via a display.

Example 84. The system of Example 83, wherein the indication comprises a tooth segmentation mask, the tooth segmentation mask comprising the determined tooth masks and the determined tooth identifiers.

Example 85. The system of Example 83 or 84, wherein the indication comprises an overlay superimposed on the patient's teeth in the 2D image, the overlay comprising the determined tooth masks and the determined tooth identifiers.

Example 86. The system of any one of Examples 83 to 85, wherein the display is remote from the one or more processors.

Example 87. The system of any one of Examples 77 to 86, wherein the operations further comprise:
detecting a disease, a change in the patient, or a condition of the patient's teeth based on the 2D image and the tooth assignments, and
outputting an indication of the disease, the change in the patient, or the condition of the patient's teeth to a user via a display.

Example 88. The system of any one of Examples 77 to 87, wherein the operations further comprise:
determining progress of the patient's teeth with respect to a dental treatment plan based on the 2D image and the tooth assignments, and
outputting an indication of the progress to a user via a display.

Example 89. The system of any one of Examples 77 to 88, wherein the 2D image comprises a photograph, a frame of a video, or a radiograph.

Example 90. The system of any one of Examples 77 to 89, wherein the 2D image is obtained from an imaging device that is remote from the one or more processors.

Example 91. The system of Example 90, wherein the imaging device comprises a camera that is part of or is operably coupled to a mobile device.

Example 92. The system of any one of Examples 77 to 91, wherein the one or more processors are part of a local client device.

Example 93. The system of any one of Examples 77 to 91, wherein the one or more processors are part of a server computing device.

Example 94. A computer-implemented method for identifying teeth in a patient image, the computer-implemented method comprising, by one or more processors:
accessing a two-dimensional (2D) image comprising a depiction of a patient's teeth;
transmitting, to a server computing device, the 2D image; and
receiving, from the server computing device, a tooth assignment for each tooth of the patient's teeth in the 2D image, wherein the tooth assignments are generated by:
   applying a segmentation algorithm to the 2D image, wherein the segmentation algorithm is configured to:
      identify a plurality of regions in the 2D image, each region corresponding to an estimated location of a tooth of the patient's teeth in the 2D image, and
      determine a tooth mask and a tooth identifier for each tooth of the patient's teeth in the 2D image, wherein the determination for each tooth is based on features of the region corresponding to the estimated location of the tooth and features of the regions corresponding to estimated locations of one or more teeth proximate to the tooth; and
generating tooth assignments by assigning each tooth of the patient's teeth in the 2D image to the respective determined tooth mask and the respective determined tooth identifier.

Example 95. The computer-implemented method of Example 94, wherein the segmentation algorithm comprises an attention mechanism that determines the tooth mask and the tooth identifier for each tooth based on the features of the region corresponding to the estimated location of the tooth and the features of the regions corresponding to estimated locations of the one or more teeth proximate to the tooth.

Example 96. The computer-implemented method of Example 95, wherein the attention mechanism comprises a multi-head self-attention mechanism.

Example 97. The computer-implemented method of any one of Examples 94 to 96, wherein the segmentation algorithm is further configured to adjust at least some of the tooth masks to reduce topological errors in the tooth masks.

Example 98. The computer-implemented method of Example 97, wherein the segmentation algorithm is configured to perform the adjustment based on a topological loss function.

Example 99. The computer-implemented method of any one of Examples 94 to 98, wherein the segmentation algorithm comprises an object instance segmentation algorithm, a semantic segmentation algorithm, or a combination thereof.

Example 100. The computer-implemented method of any one of Examples 94 to 99, further comprising outputting an indication of the tooth assignments to a user via a display.

Example 101. The computer-implemented method of Example 100, wherein the indication comprises a tooth segmentation mask, the tooth segmentation mask comprising the determined tooth masks and the corresponding tooth identifiers.

Example 102. The computer-implemented method of Example 100 or 101, wherein the indication comprises an overlay superimposed on the patient's teeth in the 2D image, the overlay comprising the determined tooth masks and the corresponding tooth identifiers.

Example 103. The computer-implemented method of any one of Examples 100 to 102, wherein the display is remote from the one or more processors.

Example 104. The computer-implemented method of any one of Examples 94 to 103, further comprising:
detecting a disease, a change in the patient, or a condition of the patient's teeth based on the 2D image and the tooth assignments, and
outputting an indication of the disease, the change in the patient, or the condition of the patient's teeth to a user via a display.

Example 105. The computer-implemented method of any one of Examples 94 to 104, further comprising:
determining progress of the patient's teeth with respect to a dental treatment plan based on the 2D image and the tooth assignments, and
outputting an indication of the progress to a user via a display.

Example 106. The computer-implemented method of any one of Examples 94 to 105, wherein the 2D image comprises a photograph, a frame of a video, or a radiograph.

Example 107. The computer-implemented method of any one of Examples 94 to 106, wherein the 2D image is obtained from an imaging device that is remote from the one or more processors.

Example 108. The computer-implemented method of Example 107, wherein the imaging device comprises a camera that is part of or is operably coupled to a mobile device.

Example 109. A computer-implemented method for identifying teeth in a patient image, the computer-implemented method comprising, by one or more processors:
accessing a two-dimensional (2D) image comprising a depiction of a patient's teeth;
applying a segmentation algorithm to the 2D image, wherein the segmentation algorithm is configured to:
   identify a plurality of regions in the 2D image, each region corresponding to an estimated location of a tooth of the patient's teeth in the 2D image, and
   determine a tooth mask and a tooth identifier for each tooth of the patient's teeth in the 2D image, wherein the determination for each tooth is based on features of the region corresponding to the estimated location of the tooth and features of the regions corresponding to estimated locations of one or more teeth proximate to the tooth; and
generating tooth assignments by assigning each tooth of the patient's teeth in the 2D image to the respective determined tooth mask and the respective determined tooth identifier.

Example 110. The computer-implemented method of Example 109, wherein the segmentation algorithm comprises an attention mechanism that determines the tooth mask and the tooth identifier for each tooth based on the features of the region corresponding to the estimated location of the tooth and the features of the regions corresponding to estimated locations of the one or more teeth proximate to the tooth.

Example 111. The computer-implemented method of Example 110, wherein the attention mechanism comprises a multi-head self-attention mechanism.

Example 112. The computer-implemented method of any one of Examples 109 to 111, wherein the segmentation algorithm is further configured to adjust at least some of the tooth masks to reduce topological errors in the tooth masks.

Example 113. The computer-implemented method of Example 112, wherein the segmentation algorithm is configured to perform the adjustment based on a topological loss function.

Example 114. The computer-implemented method of any one of Examples 109 to 113, wherein the segmentation algorithm comprises an object instance segmentation algorithm, a semantic segmentation algorithm, or a combination thereof.

Example 115. The computer-implemented method of any one of Examples 109 to 114, further comprising outputting an indication of the tooth assignments to a user via a display.

Example 116. The computer-implemented method of Example 115, wherein the indication comprises a tooth segmentation mask, the tooth segmentation mask comprising the plurality of tooth masks and the corresponding tooth identifiers.

Example 117. The computer-implemented method of Example 109 or 116, wherein the indication comprises an overlay superimposed on the patient's teeth in the 2D image, the overlay comprising the plurality of tooth masks and the corresponding tooth identifiers.

Example 118. The computer-implemented method of any one of Examples 109 to 117, wherein the display is remote from the one or more processors.

Example 119. The computer-implemented method of any one of Examples 109 to 118, further comprising:
detecting a disease, a change in the patient, or a condition of the patient's teeth based on the 2D image and the tooth assignments, and
outputting an indication of the disease, the change in the patient, or the condition of the patient's teeth to a user via a display.

Example 120. The computer-implemented method of any one of Examples 109 to 119, further comprising:
determining progress of the patient's teeth with respect to a dental treatment plan based on the 2D image and the tooth assignments, and
outputting an indication of the progress to a user via a display.

Example 121. The computer-implemented method of any one of Examples 109 to 120, wherein the 2D image comprises a photograph, a frame of a video, or a radiograph.

Example 122. The computer-implemented method of any one of Examples 109 to 121, wherein the 2D image is obtained from an imaging device that is remote from the one or more processors.

Example 123. The computer-implemented method of Example 122, wherein the imaging device comprises a camera that is part of or is operably coupled to a mobile device.

Example 124. A non-transitory computer-readable storage medium comprising instructions that, when executed by one or more processors of a computing system, cause the computing system to perform operations comprising:
accessing a two-dimensional (2D) image comprising a depiction of a patient's teeth;
applying a segmentation algorithm to the 2D image, wherein the segmentation algorithm is configured to:
identify a plurality of regions in the 2D image, each region corresponding to an estimated location of a tooth of the patient's teeth in the 2D image, and
determine a tooth mask and a tooth identifier for each tooth of the patient's teeth in the 2D image, wherein the determination for each tooth is based on features of the region corresponding to the estimated location of the tooth and features of the regions corresponding to estimated locations of one or more teeth proximate to the tooth; and
generating tooth assignments by assigning each tooth of the patient's teeth in the 2D image to the respective determined tooth mask and the respective determined tooth identifier.

Example 125. The non-transitory computer-readable storage medium of Example 124, wherein the segmentation algorithm comprises an attention mechanism that determines the tooth mask and the tooth identifier for each tooth based on the features of the region corresponding to the estimated location of the tooth and the features of the regions corresponding to estimated locations of the one or more teeth proximate to the tooth.

Example 126. The non-transitory computer-readable storage medium of Example 125, wherein the attention mechanism comprises a multi-head self-attention mechanism.

Example 127. The non-transitory computer-readable storage medium of any one of Examples 124 to 126, wherein the segmentation algorithm is further configured to adjust at least some of the tooth masks to reduce topological errors in the tooth masks.

Example 128. The non-transitory computer-readable storage medium of Example 127, wherein the segmentation algorithm is configured to perform the adjustment based on a topological loss function.

Example 129. The non-transitory computer-readable storage medium of any one of Examples 124 to 128, wherein the segmentation algorithm comprises an object instance segmentation algorithm, a semantic segmentation algorithm, or a combination thereof.

Example 130. The non-transitory computer-readable storage medium of any one of Examples 124 to 129, wherein the operations further comprise outputting an indication of the tooth assignments to a user via a display.

Example 131. The non-transitory computer-readable storage medium of Example 130, wherein the indication comprises a tooth segmentation mask, the tooth segmentation mask comprising the plurality of tooth masks and the corresponding tooth identifiers.

Example 132. The non-transitory computer-readable storage medium of Example 130 or 131, wherein the indication comprises an overlay superimposed on the patient's teeth in the 2D image, the overlay comprising the plurality of tooth masks and the corresponding tooth identifiers.

Example 133. The non-transitory computer-readable storage medium of any one of Examples 130 to 132, wherein the display is remote from the one or more processors.

Example 134. The non-transitory computer-readable storage medium of any one of Examples 124 to 133, further comprising:
detecting a disease, a change in the patient, or a condition of the patient's teeth based on the 2D image and the tooth assignments, and
outputting an indication of the disease, the change in the patient, or the condition of the patient's teeth to a user via a display.

Example 135. The non-transitory computer-readable storage medium of any one of Examples 124 to 134, further comprising:
determining progress of the patient's teeth with respect to a dental treatment plan based on the 2D image and the tooth assignments, and
outputting an indication of the progress to a user via a display.

Example 136. The non-transitory computer-readable storage medium of any one of Examples 124 to 135, wherein the 2D image comprises a photograph, a frame of a video, or a radiograph.

Example 137. The non-transitory computer-readable storage medium of any one of Examples 124 to 136, wherein the 2D image is obtained from an imaging device that is remote from the one or more processors.

Example 138. The non-transitory computer-readable storage medium of Example 137, wherein the imaging device comprises a camera that is part of or is operably coupled to a mobile device.

Example 139. A system for identifying teeth in a patient image, the system comprising:
one or more processors; and
a memory operably coupled to the one or more processors and storing instructions that, when executed by the one or more processors, cause the system to perform operations comprising:
   accessing a two-dimensional (2D) image comprising a depiction of a patient's teeth;
   generating a tooth mask and a first tooth identifier for each tooth of the patient's teeth in the 2D image by applying a segmentation algorithm to the 2D image;
   generating an input sequence comprising the tooth masks for the patient's teeth, wherein the tooth masks are ordered in the input sequence based on the first tooth identifiers;
   determining a second tooth identifier for each tooth mask by applying a sequence processing algorithm to the input sequence, wherein the sequence processing algorithm is configured to determine the second tooth identifier for each tooth mask based on features of the tooth masks of one or more teeth proximate to the tooth corresponding to the tooth mask; and
   generating tooth assignments by assigning each tooth of the patient's teeth in the 2D image to the respective tooth mask and the respective determined second tooth identifier.

Example 140. The system of Example 139, wherein the sequence processing algorithm comprises a recurrent neural network (RNN).

Example 141. The system of Example 140, wherein the RNN comprises a bidirectional long short-term memory model or an encoder-decoder model.

Example 142. The system of any one of Examples 139 to 141, wherein the features of the tooth masks comprise one or more of the following, for each tooth mask: a relative location of the tooth mask, a size of the tooth mask, or a shape of the tooth mask.

Example 143. The system of any one of Examples 139 to 142, wherein the segmentation algorithm is further configured to adjust at least some of the tooth masks to reduce topological errors in the tooth masks.

Example 144. The system of Example 143, wherein the segmentation algorithm is configured to perform the adjustment based on a topological loss function.

Example 145. The system of any one of Examples 139 to 144, wherein the segmentation algorithm comprises an object instance segmentation algorithm, a semantic segmentation algorithm, or a combination thereof.

Example 146. The system of any one of Examples 139 to 145, wherein the operations further comprise outputting an indication of the tooth assignments to a user via a display.

Example 147. The system of Example 146, wherein the indication comprises a tooth segmentation mask, the tooth segmentation mask comprising the tooth masks and the determined second tooth identifiers.

Example 148. The system of Example 146 or 147, wherein the indication comprises an overlay superimposed on the patient's teeth in the 2D image, the overlay comprising the tooth masks and the determined second tooth identifiers.

Example 149. The system of any one of Examples 146 to 148, wherein the display is remote from the one or more processors.

Example 150. The system of any one of Examples 139 to 149, wherein the operations further comprise:
detecting a disease, a change in the patient, or a condition of the patient's teeth based on the 2D image and the tooth assignments, and
outputting an indication of the disease, the change in the patient, or the condition of the patient's teeth to a user via a display.

Example 151. The system of any one of Examples 139 to 150, wherein the operations further comprise:
determining progress of the patient's teeth with respect to a dental treatment plan based on the 2D image and the tooth assignments, and
outputting an indication of the progress to a user via a display.

Example 152. The system of any one of Examples 139 to 151, wherein the 2D image comprises a photograph, a frame of a video, or a radiograph.

Example 153. The system of any one of Examples 139 to 152, wherein the 2D image is obtained from an imaging device that is remote from the one or more processors.

Example 154. The system of Example 153, wherein the imaging device comprises a camera that is part of or is operably coupled to a mobile device.

Example 155. The system of any one of Examples 139 to 154, wherein the one or more processors are part of a local client device.

Example 156. The system of any one of Examples 139 to 154, wherein the one or more processors are part of a server computing device.

Example 157. A computer-implemented method for identifying teeth in a patient image, the computer-implemented method comprising, by one or more processors:
accessing a two-dimensional (2D) image comprising a depiction of a patient's teeth;
transmitting, to a server computing device, the 2D image; and
receiving, from the server computing device, a tooth assignment for each tooth of the patient's teeth in the 2D image, wherein the tooth assignments are generated by:
   generating a tooth mask and a first tooth identifier for each tooth of the patient's teeth in the 2D image by applying a segmentation algorithm to the 2D image;
   generating an input sequence comprising the tooth masks for the patient's teeth, wherein the tooth masks are ordered in the input sequence based on the first tooth identifiers;
   determining a second tooth identifier for each tooth mask by applying a sequence processing algorithm to the input sequence, wherein the sequence processing algorithm is configured to determine the second tooth identifier for each tooth mask based on features of the tooth masks of one or more teeth proximate to the tooth corresponding to the tooth mask; and
   generating tooth assignments by assigning each tooth of the patient's teeth in the 2D image to the respective tooth mask and the respective determined second tooth identifier.

Example 158. The computer-implemented method of Example 157, wherein the sequence processing algorithm comprises a recurrent neural network (RNN).

Example 159. The computer-implemented method of Example 158, wherein the RNN comprises a bidirectional long short-term memory model or an encoder-decoder model.

Example 160. The computer-implemented method of any one of Examples 157 to 159, wherein the features of the tooth masks comprise one or more of the following, for each tooth mask: a relative location of the tooth mask, a size of the tooth mask, or a shape of the tooth mask.

Example 161. The computer-implemented method of any one of Examples 157 to 160, wherein the segmentation algorithm is further configured to adjust at least some of the tooth masks to reduce topological errors in the tooth masks.

Example 162. The computer-implemented method of Example 161, wherein the segmentation algorithm is configured to perform the adjustment based on a topological loss function.

Example 163. The computer-implemented method of any one of Examples 157 to 162, wherein the segmentation algorithm comprises an object instance segmentation algorithm, a semantic segmentation algorithm, or a combination thereof.

Example 164. The computer-implemented method of any one of Examples 157 to 163, further comprising outputting an indication of the tooth assignments to a user via a display.

Example 165. The computer-implemented method of Example 164, wherein the indication comprises a tooth segmentation mask, the tooth segmentation mask comprising the tooth masks and the determined second tooth identifiers.

Example 166. The computer-implemented method of Example 164 or 165, wherein the indication comprises an overlay superimposed on the patient's teeth in the 2D image, the overlay comprising the tooth masks and the determined second tooth identifiers.

Example 167. The computer-implemented method of any one of Examples 157 to 166, wherein the display is remote from the one or more processors.

Example 168. The computer-implemented method of any one of Examples 157 to 167, further comprising:
detecting a disease, a change in the patient, or a condition of the patient's teeth based on the 2D image and the tooth assignments, and
outputting an indication of the disease, the change in the patient, or the condition of the patient's teeth to a user via a display.

Example 169. The computer-implemented method of any one of Examples 157 to 168, further comprising:
determining progress of the patient's teeth with respect to a dental treatment plan based on the 2D image and the tooth assignments, and
outputting an indication of the progress to a user via a display.

Example 170. The computer-implemented method of any one of Examples 157 to 169, wherein the 2D image comprises a photograph, a frame of a video, or a radiograph.

Example 171. The computer-implemented method of any one of Examples 157 to 170, wherein the 2D image is obtained from an imaging device that is remote from the one or more processors.

Example 172. The computer-implemented method of Example 171, wherein the imaging device comprises a camera that is part of or is operably coupled to a mobile device.

Example 173. A computer-implemented method for identifying teeth in a patient image, the computer-implemented method comprising, by one or more processors:
accessing a two-dimensional (2D) image comprising a depiction of a patient's teeth;
generating a tooth mask and a first tooth identifier for each tooth of the patient's teeth in the 2D image by applying a segmentation algorithm to the 2D image;
generating an input sequence comprising the tooth masks for the patient's teeth, wherein the tooth masks are ordered in the input sequence based on the first tooth identifiers;
determining a second tooth identifier for each tooth mask by applying a sequence processing algorithm to the input sequence, wherein the sequence processing algorithm is configured to determine the second tooth identifier for each tooth mask based on features of the tooth masks of one or more teeth proximate to the tooth corresponding to the tooth mask; and
generating tooth assignments by assigning each tooth of the patient's teeth in the 2D image to the respective tooth mask and the respective determined second tooth identifier.

Example 174. The computer-implemented method of Example 173, wherein the sequence processing algorithm comprises a recurrent neural network (RNN).

Example 175. The computer-implemented method of Example 174, wherein the RNN comprises a bidirectional long short-term memory model or an encoder-decoder model.

Example 176. The computer-implemented method of any one of Examples 173 to 175, wherein the features of the tooth masks comprise one or more of the following, for each tooth mask: a relative location of the tooth mask, a size of the tooth mask, or a shape of the tooth mask.

Example 177. The computer-implemented method of any one of Examples 173 to 176, wherein the segmentation algorithm is further configured to adjust at least some of the tooth masks to reduce topological errors in the tooth masks.

Example 178. The computer-implemented method of Example 177, wherein the segmentation algorithm is configured to perform the adjustment based on a topological loss function.

Example 179. The computer-implemented method of any one of Examples 173 to 178, wherein the segmentation algorithm comprises an object instance segmentation algorithm, a semantic segmentation algorithm, or a combination thereof.

Example 180. The computer-implemented method of any one of Examples 173 to 179, further comprising outputting an indication of the tooth assignments to a user via a display.

Example 181. The computer-implemented method of Example 180, wherein the indication comprises a tooth segmentation mask, the tooth segmentation mask comprising the tooth masks and the determined second tooth identifiers.

Example 182. The computer-implemented method of Example 173 or 181, wherein the indication comprises an overlay superimposed on the patient's teeth in the 2D image, the overlay comprising the tooth masks and the determined second tooth identifiers.

Example 183. The computer-implemented method of any one of Examples 173 to 182, wherein the display is remote from the one or more processors.

Example 184. The computer-implemented method of any one of Examples 173 to 183, further comprising:
detecting a disease, a change in the patient, or a condition of the patient's teeth based on the 2D image and the tooth assignments, and
outputting an indication of the disease, the change in the patient, or the condition of the patient's teeth to a user via a display.

Example 185. The computer-implemented method of any one of Examples 173 to 184, further comprising:
determining progress of the patient's teeth with respect to a dental treatment plan based on the 2D image and the tooth assignments, and
outputting an indication of the progress to a user via a display.

Example 186. The computer-implemented method of any one of Examples 173 to 185, wherein the 2D image comprises a photograph, a frame of a video, or a radiograph.

Example 187. The computer-implemented method of any one of Examples 173 to 186, wherein the 2D image is obtained from an imaging device that is remote from the one or more processors.

Example 188. The computer-implemented method of Example 187, wherein the imaging device comprises a camera that is part of or is operably coupled to a mobile device.

Example 189. A non-transitory computer-readable storage medium comprising instructions that, when executed by one or more processors of a computing system, cause the computing system to perform operations comprising:
accessing a two-dimensional (2D) image comprising a depiction of a patient's teeth;
generating a tooth mask and a first tooth identifier for each tooth of the patient's teeth in the 2D image by applying a segmentation algorithm to the 2D image;
generating an input sequence comprising the tooth masks for the patient's teeth, wherein the tooth masks are ordered in the input sequence based on the first tooth identifiers;
determining a second tooth identifier for each tooth mask by applying a sequence processing algorithm to the input sequence, wherein the sequence processing algorithm is configured to determine the second tooth identifier for each tooth mask based on features of the tooth masks of one or more teeth proximate to the tooth corresponding to the tooth mask; and
generating tooth assignments by assigning each tooth of the patient's teeth in the 2D image to the respective tooth mask and the respective determined second tooth identifier.

Example 190. The non-transitory computer-readable storage medium of Example 189, wherein the sequence processing algorithm comprises a recurrent neural network (RNN).

Example 191. The non-transitory computer-readable storage medium of Example 190, wherein the RNN comprises a bidirectional long short-term memory model or an encoder-decoder model.

Example 192. The non-transitory computer-readable storage medium of any one of Examples 189 to 191, wherein the features of the tooth masks comprise one or more of the following, for each tooth mask: a relative location of the tooth mask, a size of the tooth mask, or a shape of the tooth mask.

Example 193. The non-transitory computer-readable storage medium of any one of Examples 189 to 192, wherein the segmentation algorithm is further configured to adjust at least some of the tooth masks to reduce topological errors in the tooth masks.

Example 194. The non-transitory computer-readable storage medium of Example 193, wherein the segmentation algorithm is configured to perform the adjustment based on a topological loss function.

Example 195. The non-transitory computer-readable storage medium of any one of Examples 189 to 194, wherein the segmentation algorithm comprises an object instance segmentation algorithm, a semantic segmentation algorithm, or a combination thereof.

Example 196. The non-transitory computer-readable storage medium of any one of Examples 189 to 195, wherein the operations further comprise outputting an indication of the tooth assignments to a user via a display.

Example 197. The non-transitory computer-readable storage medium of Example 196, wherein the indication comprises a tooth segmentation mask, the tooth segmentation mask comprising the tooth masks and the determined second tooth identifiers.

Example 198. The non-transitory computer-readable storage medium of Example 196 or 197, wherein the indication comprises an overlay superimposed on the patient's teeth in the 2D image, the overlay comprising the tooth masks and the determined second tooth identifiers.

Example 199. The non-transitory computer-readable storage medium of any one of Examples 196 to 198, wherein the display is remote from the one or more processors.

Example 200. The non-transitory computer-readable storage medium of any one of Examples 189 to 199, wherein the operations further comprise:
detecting a disease, a change in the patient, or a condition of the patient's teeth based on the 2D image and the tooth assignments, and
outputting an indication of the disease, the change in the patient, or the condition of the patient's teeth to a user via a display.

Example 201. The non-transitory computer-readable storage medium of any one of Examples 189 to 200, wherein the operations further comprise:
determining progress of the patient's teeth with respect to a dental treatment plan based on the 2D image and the tooth assignments, and
outputting an indication of the progress to a user via a display.

Example 202. The non-transitory computer-readable storage medium of any one of Examples 189 to 201, wherein the 2D image comprises a photograph, a frame of a video, or a radiograph.

Example 203. The non-transitory computer-readable storage medium of any one of Examples 189 to 202, wherein the 2D image is obtained from an imaging device that is remote from the one or more processors.

Example 204. The non-transitory computer-readable storage medium of Example 203, wherein the imaging device comprises a camera that is part of or is operably coupled to a mobile device.

Example 205. A method for treating a patient, the method comprising:
detecting the disease, the change in the patient, or the condition of the patient's teeth according to the computer-implemented method of any one of Examples 31, 51, 104, 119, 168, and 184; and
administering a treatment to the patient that is configured to treat the disease, the change in the patient, or the condition of the patient's teeth.

Example 206. A method for treating a patient, the method comprising:
determining the progress of the patient's teeth with respect to the dental treatment plan according to the computer-implemented method of any one of Examples 32, 52, 105, 120, 169, and 185;
determining a modified dental treatment plan, based on the determined progress of the patient's teeth; and
administering the modified dental treatment plan to the patient.

### Conclusion

Although many of the embodiments are described above with respect to systems, devices, and methods for tooth segmentation and identification, the technology is applicable to other applications and/or other approaches, such as segmentation and identification of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-16.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A system for identifying teeth in a patient image, the system comprising:
one or more processors; and
a memory operably coupled to the one or more processors and storing instructions that, when executed by the one or more processors, cause the system to perform operations comprising:
accessing a two-dimensional (2D) image comprising a depiction of a patient's teeth;
applying a segmentation algorithm to the 2D image, wherein the segmentation algorithm is configured to:
identify a plurality of regions in the 2D image, each region corresponding to an estimated location of a tooth of the patient's teeth in the 2D image, and
determine a tooth mask and a tooth identifier for each tooth of the patient's teeth in the 2D image, wherein the determination for each tooth is based on features of the region corresponding to the estimated location of the tooth and features of the regions corresponding to estimated locations of one or more teeth proximate to the tooth; and
generating tooth assignments by assigning each tooth of the patient's teeth in the 2D image to the respective determined tooth mask and the respective determined tooth identifier.

2. The system of claim 1, wherein the segmentation algorithm comprises an attention mechanism that determines the tooth mask and the tooth identifier for each tooth based on the features of the region corresponding to the estimated location of the tooth and the features of the regions corresponding to estimated locations of the one or more teeth proximate to the tooth.

3. The system of claim 2, wherein the attention mechanism comprises a multi-head self-attention mechanism.

4. The system of claim 1, wherein the segmentation algorithm is further configured to adjust at least some of the tooth masks to reduce topological errors in the tooth masks.

5. The system of claim 4, wherein the segmentation algorithm is configured to perform the adjustment based on a topological loss function.

6. The system of claim 1, wherein the segmentation algorithm comprises an object instance segmentation algorithm, a semantic segmentation algorithm, or a combination thereof.

7. The system of claim 1, wherein the operations further comprise outputting an indication of the tooth assignments to a user via a display.

8. The system of claim 7, wherein the indication comprises an overlay superimposed on the patient's teeth in the 2D image, the overlay comprising the determined tooth masks and the determined tooth identifiers.

9. The system of claim 1, wherein the operations further comprise:
detecting a disease, a change in the patient, or a condition of the patient's teeth based on the 2D image and the tooth assignments, and
outputting an indication of the disease, the change in the patient, or the condition of the patient's teeth to a user via a display.

10. The system of claim 1, wherein the operations further comprise:
determining progress of the patient's teeth with respect to a dental treatment plan based on the 2D image and the tooth assignments, and
outputting an indication of the progress to a user via a display.

11. The system of claim 1, wherein the 2D image is obtained from an imaging device that is remote from the one or more processors.

12. The system of claim 1, wherein the one or more processors are part of a local client device.

13. A computer-implemented method for identifying teeth in a patient image, the computer-implemented method comprising, by one or more processors:
accessing a two-dimensional (2D) image comprising a depiction of a patient's teeth;
transmitting, to a server computing device, the 2D image; and
receiving, from the server computing device, a tooth assignment for each tooth of the patient's teeth in the 2D image, wherein the tooth assignments are generated by:
applying a segmentation algorithm to the 2D image, wherein the segmentation algorithm is configured to:
identify a plurality of regions in the 2D image, each region corresponding to an estimated location of a tooth of the patient's teeth in the 2D image, and
determine a tooth mask and a tooth identifier for each tooth of the patient's teeth in the 2D image, wherein the determination for each tooth is based on features of the region corresponding to the estimated location of the tooth and features of the regions corresponding to estimated locations of one or more teeth proximate to the tooth; and
generating tooth assignments by assigning each tooth of the patient's teeth in the 2D image to the respective determined tooth mask and the respective determined tooth identifier.

14. The computer-implemented method of claim 13, wherein the segmentation algorithm comprises an attention mechanism that determines the tooth mask and the tooth identifier for each tooth based on the features of the region corresponding to the estimated location of the tooth and the features of the regions corresponding to estimated locations of the one or more teeth proximate to the tooth.

15. The computer-implemented method of claim 14, wherein the attention mechanism comprises a multi-head self-attention mechanism.

16. The computer-implemented method of claim 13, wherein the segmentation algorithm is further configured to adjust at least some of the tooth masks to reduce topological errors in the tooth masks.

17. The computer-implemented method of claim 16, wherein the segmentation algorithm is configured to perform the adjustment based on a topological loss function.

18. A computer-implemented method for identifying teeth in a patient image, the computer-implemented method comprising, by one or more processors:
accessing a two-dimensional (2D) image comprising a depiction of a patient's teeth;
applying a segmentation algorithm to the 2D image, wherein the segmentation algorithm is configured to:
identify a plurality of regions in the 2D image, each region corresponding to an estimated location of a tooth of the patient's teeth in the 2D image, and
determine a tooth mask and a tooth identifier for each tooth of the patient's teeth in the 2D image, wherein the determination for each tooth is based on features of the region corresponding to the estimated location of the tooth and features of the regions corresponding to estimated locations of one or more teeth proximate to the tooth; and
generating tooth assignments by assigning each tooth of the patient's teeth in the 2D image to the respective determined tooth mask and the respective determined tooth identifier.

19. The computer-implemented method of claim 18, wherein the segmentation algorithm comprises an attention mechanism that determines the tooth mask and the tooth identifier for each tooth based on the features of the region corresponding to the estimated location of the tooth and the features of the regions corresponding to estimated locations of the one or more teeth proximate to the tooth.

20. The computer-implemented method of claim 18, wherein the segmentation algorithm is further configured to adjust at least some of the tooth masks to reduce topological errors in the tooth masks.
